(19) United States
(12) Patent Application Publication
(10) Pub. No.: US 2026/0254900 A1
(43) Pub. Date: Aug. 27, 2026

(54) ELECTRONIC DEVICE, SERVER, DISPLAY SYSTEM, AND ELECTRONIC DEVICE DISPLAY CONTROL METHOD

(71) Applicant: SEIKO EPSON CORPORATION, Tokyo (JP)

(72) Inventor: Yuji TAKASE, KITAKYUSHU-SHI (JP)

(21) Appl. No.: 19/548,118

(22) Filed: Feb. 24, 2026

(30) Foreign Application Priority Data
Feb. 25, 2025 (JP) 2025-027642

(51) Int. Cl. H04N 1/00

(52) U.S. Cl. CPC H04N 1/00506; H04N 1/00244; H04N 1/00464; H04N 1/00482; H04N 1/0097; H04N 2201/0081

(57) ABSTRACT

An electronic device includes following a display section is configured to display a setting screen to set image generation conditions. A storage section configured to stores one or more pieces of first display data configured to display a first setting screen. A communication section is configured to be connected via a network to a server that stores one or more pieces of second display data, the second display data being able to cause display of a second setting screen different from the first setting screen. When the second setting screen is displayed on the display section, a control section causes the display section to simultaneously display the second setting screen and the first setting screen associated with a first operation in a split manner when the first operation in which a selection selected section in the second setting screen is selected by an operation section is received.

The present application is based on, and claims priority from JP Application Serial Number 2025-027642, filed February 25, 2025, the disclosure of which is hereby incorporated by reference herein in its entirety.

### BACKGROUND

### 1. Technical Field

The present disclosure relates to an electronic device having a display section, a server, a display system, and an electronic device display control method.

### 2. Related Art

For example, JP-A-2019-165427 discloses a technique of providing a screen of a control application of an electronic device and application software for providing a function (hereinafter referred to as a function providing application). The electronic device displays a display mode based on the display data downloaded from the server on the display section. The function providing application is configured to unify a display mode of a user interface (UI) of an application that calls the function provided by the function providing application and a display mode of the UI of the function providing application.

The electronic device displays, as a UI to be visually checked by the user, a setting screen on the display section when setting image generation conditions to generate an image using a medium. The UI of the function providing application is displayed on the display section as a first setting screen including a native UI that is a UI unique to the electronic device. On the other hand, the UI of the application that calls the function provided by the function providing application is displayed on the display section as the second setting screen including the browser UI. The second setting screen is, for example, provided for a specific user from a vendor or the like.

However, according to the technique described in JP-A-2019-165427, when the second setting screen, which is the UI of the application that calls the function provided by the function providing application, is displayed, the first setting screen, which is the UI of the function providing application, is not available. There is a screen including UI information and the like that is present only in the first setting screen. Even if the first setting screen and the second setting screen are switched and displayed on the display section, when the screens are switched, it is difficult to grasp the relationship of information between both setting screens, and thus there is a problem in that usability for the user is poor. Therefore, there is room for improvement in the usability for the user in the electronic device configured to display the second setting screen based on the display data received from the server.

### SUMMARY

An electronic device that solves the above problem is, an electronic device including an action section that performs an action to generate an image using a medium, the electronic device including a display section configured to display a setting screen that is to be visually checked by a user after setting an image generation condition, which is a condition for generating the image; an operation section configured to enable an operation on the setting screen; a storage section configured to store one or more pieces of first display data to display a first setting screen, which is one display mode of the setting screen; a communication section connectable via a network to a server storing one or more pieces of second display data that enables display of a second setting screen, which is another display mode of the setting screen; and a control section configured to, when a first operation of selecting a selected section in the second setting screen is received by the operation section while the second setting screen based on the second display data is being displayed on the display section, cause the display section to simultaneously display, in a split manner, the second setting screen and the first setting screen, which is based on the first display data associated with the first operation.

A server that solves the above problem is a server connected to the electronic device via the network, the server including a second storage section configured to store one or more pieces of second display data that enables displaying a second setting screen that is another display mode of the setting screen; a server-side display control section that sends, to the electronic device, together with the second display data, an instruction to display the second setting screen based on the second display data on the display section; and a second split display control section configured to, when the control section of the electronic device receives a first operation to select a selected section in the second setting screen by the operation section while the second setting screen based on the second display data is being displayed on the display section, receive, from the electronic device via the network, first operation position information based on the first operation, wherein the second split display control section sends, to the electronic device, a display instruction to cause display, on the display section, of the first setting screen based on the first display data associated with the first operation position information, to cause the control section to simultaneously display, in a split manner, on the display section, the second setting screen and the first setting screen, which is based on the first display data that was read from the storage section in accordance with the display instruction.

A display system that solves the above problem includes the electronic device and the server.

The electronic device includes an action section that performs the action to generate the image using the medium, the electronic device including a display section configured to display a setting screen that is to be visually checked by a user after setting an image generation condition, which is a condition for generating the image; an operation section configured to enable an operation on the setting screen; a storage section configured to store one or more pieces of first display data to display a first setting screen, which is one display mode of the setting screen; a communication section connectable via a network to a server storing one or more pieces of second display data that enables display of a second setting screen, which is another display mode of the setting screen; and a control section that controls the display section, wherein the control section when a second operation of selecting a selected section in the first setting screen is received by the operation section while the first setting screen based on the first display data is being displayed on the display section, sends second operation position information that indicates an operation position of the second operation to the server and causes the first setting screen and the second setting screen, which is based on the second display data received from the server as a response to the second operation position information, to be simultaneously displayed, in a split manner, on the display section.

A server that solves the above problem is a server connected to the electronic device via the network, the server including a second storage section configured to store one or more pieces of second display data that enables displaying a second setting screen that is another display mode of the setting screen; a server-side display control section that sends, to the electronic device, together with the second display data, an instruction to display the second setting screen based on the second display data on the display section; and a second split display control section that receives second operation position information from the electronic device via the network, wherein the second split display control section performs an image acquisition process associated with the second operation position information to acquire new second display data different from the second display data that was stored in the second storage section before the image acquisition process, and sends, to the electronic device together with the new second display data, a display instruction to cause the display section to display the second setting screen based on the new second display data, thereby causing the control section to simultaneously display, in a split manner, the first setting screen and the second setting screen based on the new second display data on the display section.

A display system that solves the above problem includes the electronic device and the server.

An electronic device display control method that solves the above problem is a display control method that controls a display section provided in an electronic device, the electronic device including an action section that performs an action to generate an image using a medium; a display section configured to display a setting screen that is to be visually checked by a user after setting an image generation condition, which is a condition for generating the image; an operation section configured to enable an operation on the setting screen; a storage section configured to store one or more pieces of first display data to display a first setting screen, which is one display mode of the setting screen; and a communication section connectable via a network to a server storing one or more pieces of second display data that enables display of a second setting screen, which is another display mode of the setting screen, the display control method including

(A1) when the second setting screen based on the second display data is displayed on the display section, receiving a first operation in which the selected section in the second setting screen is selected by the operation section and

(A2) when the first operation is received, displaying, on the display section simultaneously in a split manner, the second setting screen and a first setting screen based on the first display data associated with the first operation.

An electronic device display control method that solves the above problem is a display control method that controls a display section provided in an electronic device,the electronic device including an action section that performs an action to generate an image using a medium, a display section configured to display a setting screen that is to be visually checked by a user after setting an image generation condition, which is a condition for generating the image, the operation section configured to perform the operation on the setting screen, the storage section configured to store one or more pieces of first display data to display the first setting screen that is one display mode of the setting screen, and a communication section connectable via a network to a server storing one or more pieces of second display data that enables display of a second setting screen, which is another display mode of the setting screen, the display control method including

(B1) when the first setting screen based on the first display data is displayed on the display section, upon receiving a second operation in which a selected section in the first setting screen is selected by the operation section, sending second operation position information indicating an operation position of the second operation to the server and

(B2) displaying, on the display section simultaneously in a split manner, the first setting screen and the second setting screen, which is based on the second display data received from the server as a response to the second operation position information.

### BRIEF DESCRIPTION OF THE DRAWINGS

FIG. 1 is a schematic diagram illustrating a configuration of a display system including an electronic device according to a first embodiment.

FIG. 2 is a block diagram illustrating an electrical configuration of the display system.

FIG. 3 is a schematic diagram illustrating an authentication screen.

FIG. 4 is a schematic diagram illustrating a home screen, which belongs to a second setting screen.

FIG. 5 is a schematic diagram illustrating a scan setting menu screen, which belongs to the second setting screen.

FIG. 6 is a schematic diagram illustrating a scan setting screen and a setting change screen, which belongs to the second setting screen.

FIG. 7 is a schematic diagram illustrating the setting change screen.

FIG. 8 is a schematic diagram illustrating a help screen in a full-screen display format belonging to a first setting screen switched from the setting change screen.

FIG. 9 is a schematic diagram illustrating a transparent type help screen in the full-screen display format, which also belongs to the first setting screen.

FIG. 10 is a schematic diagram illustrating a split setting screen in which the setting change screen and the help screen are displayed in a split manner.

FIG. 11 is a schematic diagram illustrating the setting change screen displayed when the setting is changed on the help screen of the split setting screen.

FIG. 12 is a schematic diagram illustrating another example of the split setting screen in which the setting change screen and the help screen are displayed in a split manner.

FIG. 13 is a flowchart illustrating a screen switching control routine.

FIG. 14 is a flowchart illustrating a split display process routine.

FIG. 15 is a flowchart illustrating a touch display control routine.

FIG. 16 is a schematic diagram illustrating a storage destination selection screen, which belongs to the first setting screen in the second embodiment.

FIG. 17 is a schematic diagram illustrating a save destination detail screen, which belongs to the first setting screen.

FIG. 18 is a schematic diagram illustrating a storage destination designation screen, which belongs to the first setting screen.

FIG. 19 is a schematic diagram illustrating the split setting screen in which a storage destination selection screen, which belongs to the first setting screen, and a folder selection screen, which belongs to the second setting screen, are displayed in the split manner.

FIG. 20 is a schematic front view, partially in cross-section, illustrating an image forming device as an example of the electronic device.

### DESCRIPTION OF EMBODIMENTS

### First Embodiment

Hereinafter, a first embodiment of an electronic device and a display system including the electronic device will be described with reference to the drawings.

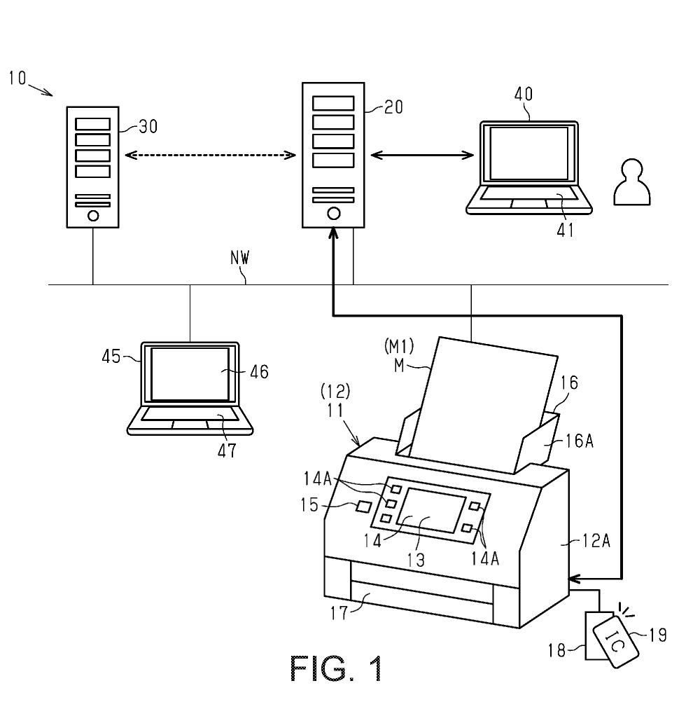

FIG. 1 illustrates a configuration of a display system 10 including an electronic device 11. As illustrated in FIG. 1, the display system 10 includes the electronic device 11 and a server 20. The display system 10 may include an authentication server 30. Here, the server 20 is also referred to as a first server 20, and the authentication server 30 is also referred to as a second server 30.

The first server 20 may be a server owned by a vendor such as an independent software vendor (ISV), a scanner manufacturer, or the like. The first server 20 may be a rental server rented by a vendor, a scanner manufacturer, or the like. The first server 20 may be an external server or a cloud server.

The display system 10 may include a management computer 40 that manages the first server 20. The management computer 40 is connectable to the first server 20. The management computer 40 is operated by an administrator who works for or is entrusted to a vendor, a scanner manufacturer, or the like, and thereby accesses the first server 20 and manages programs and data stored in the first server 20. The management computer 40 uploads and updates programs and data to the first server 20.

The display system 10 may include a terminal device 45. The terminal device 45 may be communicably connected to the first server 20 via the network NW. The terminal device 45 may be communicably connected to the electronic device 11 via a network NW such as the Internet or a local area network (LAN). The terminal device 45 may be owned by the user or may be used as a transmission destination to which the user transmits data from the electronic device 11. The terminal device 45 may be a host device used when a user gives an instruction to the electronic device 11. The terminal device 45 includes a display section 46 and an input section 47. The terminal device 45 is, for example, a personal computer, but may be a smartphone, a portable telephone, a portable information terminal (Personal Digital Assistants (PDA)), a tablet PC, or the like.

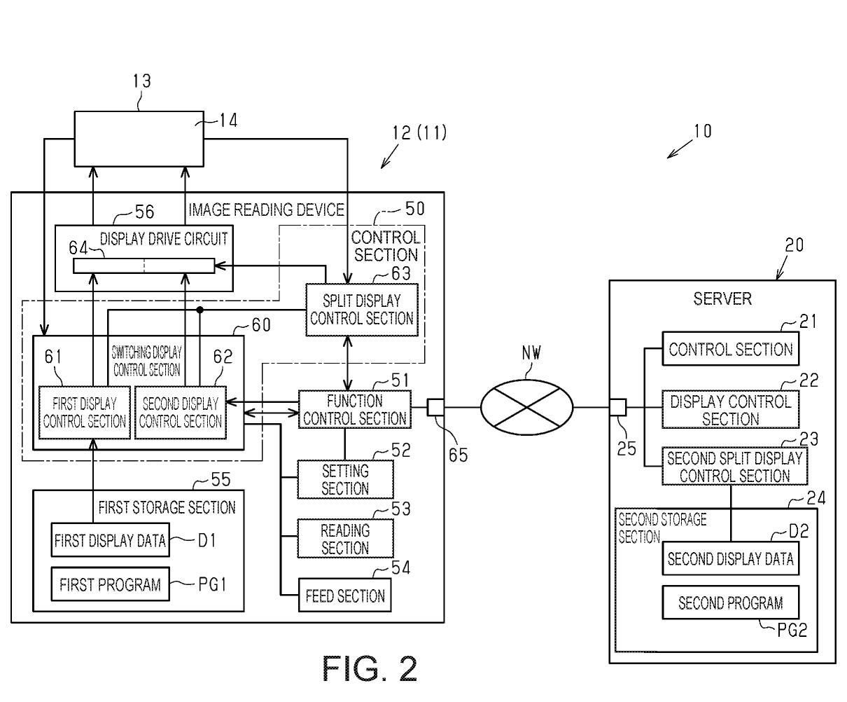

The electronic device 11 may be, for example, a device that generates an image using the medium M. In this case, the electronic device 11 may include an image acquisition section that acquires an image from the medium M. In the example illustrated in FIG. 1, the electronic device 11 is an image reading device 12 that reads an image from the medium M. The image reading device 12 includes a reading section 53 (see FIG. 2) that reads a document M1, which is an example of the medium M. That is, the image reading device 12 is a scanner including the reading section 53 as an image acquisition section. The electronic device 11 may include a feed section 54 (see FIG. 2) that transports the medium M as a target from which an image is read. That is, the image reading device 12 may be a sheet feed system image reading device including the feed section 54 that transports the document M1 in order to read the image from the document M1.

The electronic device 11 and the servers 20 and 30 are communicably connected to each other via a network NW such as the Internet. The user gives an instruction to the electronic device 11 to cause the electronic device 11 to perform a predetermined operation process. In the example illustrated in FIG. 1 in which the electronic device 11 is the image reading device 12, the user causes the electronic device 11 to perform an image reading process of reading the document M1 as the predetermined operation process.

The electronic device 11 includes a display section 13. The electronic device 11 has a main body 12A. The display section 13 is provided on the main body 12A. The display section 13 is, for example, a touch panel. The display section 13 including a touch panel includes an operation section 14 that has a touch panel function that enables input by touch operation.

The second server 30 is, for example, an authentication server owned by a company to which the user belongs. A reader 18 for authentication is connected to the electronic device 11. The user who uses the electronic device 11 performs personal authentication by touching the authentication card 19 to the reader 18. The authentication card 19 is an IC card or the like in which personal authentication information such as personal information and a password is stored. The electronic device 11 receives the personal authentication information read from the authentication card 19 by the reader 18 from the reader 18. The electronic device 11 transmits the personal authentication information to the first server 20 via the network NW. The first server 20 transmits the personal authentication information received from the electronic device 11 to the second server 30 and requests the second server 30 to perform an authentication process. The second server 30 executes the authentication process based on the personal authentication information received from the first server 20. The second server 30 transmits the authentication result information to the first server 20.

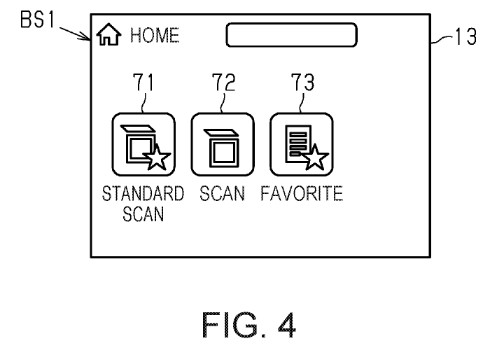

When the first server 20 confirms that the user is authenticated based on the authentication result information received from the second server 30, the first server 20 permits the login of the electronic device 11 and causes the display section 13 to display a home screen BS1 (see FIG. 4). The user can use the electronic device 11 on which the home screen BS1 is displayed. It should be noted that the authentication function may be provided in the first server 20 instead of the second server 30. In this case, the second server 30 may be omitted.

### Configuration of the electronic device 11

As illustrated in FIG. 1, the electronic device 11 includes the main body 12A. The main body 12A has a predetermined shape having a slope on the front surface. The electronic device 11 generates an image using the medium M. The medium M is, for example, the document M1. The electronic device 11 is, for example, the image reading device 12. The image reading device 12 reads the document M1 to generate an image. The image reading device 12 includes a display section 13. The electronic device 11 includes the display section 13. The display section 13 is provided on the front surface of the main body 12A. The display section 13 may be, for example, a touch panel.

The image reading device 12 displays a setting screen on the display section 13. The setting screen is a screen that is referred to by the user in setting image generation conditions that are conditions for generating an image. The electronic device 11 displays one or more setting screens on the display section 13. The one or more setting screens have a hierarchical structure and are associated with each other between the hierarchies. The setting screen will be described in detail later.

The electronic device 11 includes an operation section 14. The operation section 14 is configured to perform selection of a selected section in the setting screen displayed on the display section 13. The one or more setting screens include a setting screen having a selected section that can be selected by the user operating the operation section 14. When the display section 13 is a touch panel, the operation section 14 may be configured by a touch operation function of the touch panel. In this case, the user may select the selected section in the setting screen displayed on the display section 13 by performing a touch operation on the operation section 14 that includes the touch panel of the display section 13. The display section 13 displays a home screen (menu screen) and a setting screen that can set image reading conditions, which are an example of image generation conditions. The setting screen includes a selected section including a button, options, a slider, and the like.

The operation section 14 may be configured to, when an instruction is to be given to the image reading device 12, input necessary information in response to a touch operation by the user on the display screen of the display section 13. It should be noted that a touch operation may include drag, tap, flick, and the like. Tap refers to an operation to touch a screen with a finger and immediately remove the finger from the screen. A touch operation may include a double tap, which is tapping quickly twice. A flick is an operation of swiping a fingertip up, down, left, or right. A touch operation may include a swipe of slowly sliding the finger as if sweeping over the screen.

The electronic device 11 may include an operation section 14A including a mechanical switch. The operation section 14A may include selection buttons. The selection buttons may include selection buttons that enable selecting vertical and horizontal directions, or selection buttons that enable selecting vertical and horizontal directions. The selection buttons may include a plus button to be operated to increase a numerical value and a minus button to be operated to decrease a numerical value. The electronic device 11 may include both the operation section 14 that includes a touch panel and the operation section 14A that includes a mechanical switch.

The image reading device 12 includes a document support 16 on which a document M1 is placed. The document support 16 extends obliquely upward to the rear of the main body 12A. The document support 16 is configured to have plural sheets of documents M1 placed on it. The document support 16 has a pair of edge guides 16A that are slidable in the widthwise direction of the document M1. The user slides the pair of edge guides 16A to position the document M1 on the document support 16. The image reading device 12 includes a stacker 17 housed in a portion of a discharge port opening in a lower portion of the main body 12A so as to be slidable in the front-rear direction.

A document M1 placed on the document support 16 is fed one sheet at a time into the main body 12A through a feeding port opened at an upper portion of the main body 12A. The fed document M1 is transported along a predetermined transport path (not illustrated) in the main body 12A, and after an image is read at a reading position in the middle of the transport, the document is discharged from a discharge port opened in the front lower portion of the main body 12A. After the image is read in the main body 12A, the document M1 is discharged to the stacker 17, which is in an extended state.

### Electrical configuration of display system 10

Next, with reference to FIG. 2, electrical configuration and functional configuration of the display system 10 will be described. As illustrated in FIG. 2, the display system 10 includes an electronic device 11 and a server 20. The server 20 is connected to the electronic device 11 via the network NW and can control the display section 13 of the electronic device 11.

The electronic device 11 includes the display section 13, an operation section 14, a first storage section 55, which is an example of a storage section, a communication section 65, and a control section 50. The display section 13 is configured to be able to display a setting screen that is visually checked by the user for setting image generation conditions, which are conditions for generating an image. The operation section 14 is configured to allow an operation of selecting a selected section in the setting screen.

The first storage section 55 stores one or more pieces of first display data D1 that enable display of a first setting screen NS, which is a display mode of the setting screen. One display mode of the setting screen is a display mode of the setting screen based on the first display data D1 created by the scanner manufacturer and stored in the first storage section 55. The setting screen in one display mode created by the scanner manufacturer is the first setting screen NS. The first setting screen NS is a native UI that is a setting screen unique to the image reading device 12.

The communication section 65 is configured to be connectable to the server 20 via the network NW. The server 20 stores one or more pieces of second display data D2 for displaying a second setting screen BS, which is another display mode of the setting screen. The other display mode of the setting screen is a display mode of the setting screen based on the second display data D2 created by the vendor or the manufacturer and stored in the server 20. The setting screen of another display mode created by the vendor or the manufacturer is the second setting screen BS. The second setting screen BS is a setting screen that is created by a vendor or a manufacturer for customers in a specific field so as to be easily used. The second setting screen BS is a browser UI provided by the server 20 via the network NW such as the Internet.

When the second setting screen BS based on the second display data D2 is displayed on the display section 13, the control section 50 receives a first operation in which a selected section in the second setting screen BS is selected by the operation section 14. When the first operation is received, the control section 50 simultaneously displays, in a split manner, the second setting screen BS and the first setting screen NS based on the first display data D1 associated with the first operation on the display section 13.

The electronic device 11 further includes a function control section 51. The function control section 51 is configured by function providing application software or the like that provides the server 20 with the function of the electronic device 11. The function control section 51 receives an instruction received by the communication section 65 from the server 20. The function control section 51 passes the instruction received from the server 20 to the control section 50. The control section 50 controls the image reading device 12 in accordance with an instruction from the function control section 51. That is, the control section 50 controls the reading section 53, the feed section 54, the display drive circuit 56, and the like in accordance with an instruction from the function control section 51. When the function control section 51 receives a request or the like from the control section 50, the function control section 51 calls the server and requests a response. It should be noted that the configuration of the server 20 that sends an instruction to the electronic device 11 will be described later.

The electronic device 11 may include a setting section 52. The setting section 52 sets setting information related to a display mode for displaying a setting screen or the like on the display section 13. The administrator may write the setting information from the server 20 to the setting section 52 using the management computer 40, or the user may write the setting information to the setting section 52 by operating the operation section 14 of the electronic device 11. The user may write the setting information in the setting section 52 by operating the operation section of the terminal device 45 communicably connected to the electronic device 11. The setting information is information for setting a display mode of the first setting screen associated with the first operation when the first operation is performed on the second setting screen in a case where the second setting screen is displayed on the display section 13. The setting information is information for setting one of two types of display, that is, a full screen display and a split display. When the setting information of the setting section 52 is full screen display information, the first display control section 61 switches the display content of the display section 13 and displays the first setting screen of the display target on the entire screen. When the setting information of the setting section 52 is split display information, the split display control section 63 splits the display section 13 and simultaneously displays the second setting screen and the first setting screen.

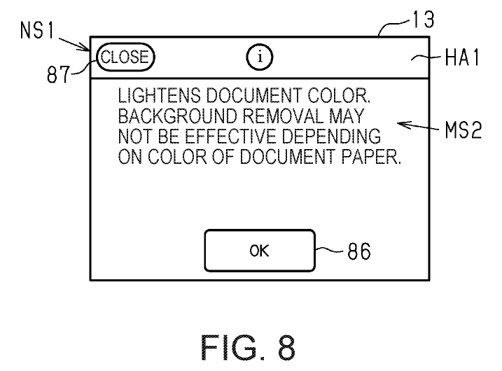

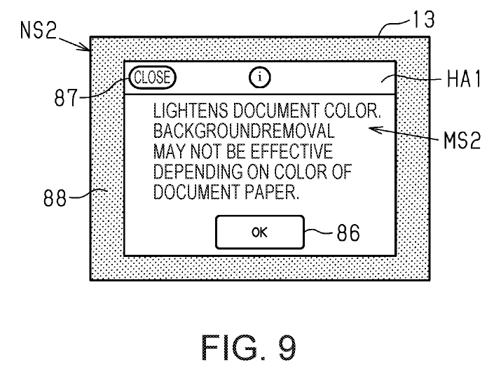

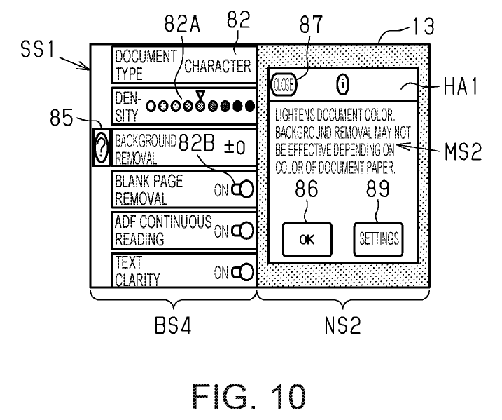

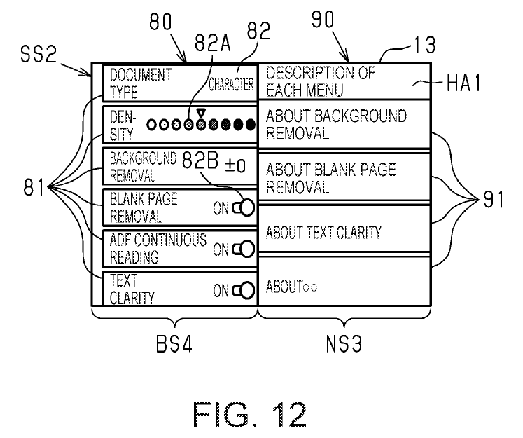

For example, "00" is set as the setting information for displaying the help screen NS1 (refer to FIG. 8), which belongs to the first setting screen NS, on the display section 13 in full screen. For example, "01" is set as the setting information for displaying a help screen NS2 (see FIG. 9), which belongs to the first setting screen NS, on the display section 13 in full screen. The help screen NS2 is different from the help screen NS1 illustrated in FIG. 8 in that the help screen NS2 has transparent region 88 through which the background is transmitted in the peripheral edge portion. That is, the setting information "00" indicates the normal (non transparent type) full screen display, and the setting information "01" indicates the transparent type full screen display. For example, "10" is set as the setting information for displaying, on the display section 13, a split setting screen SS1 (see FIG. 10) that splits display into the transparent type help screen NS2, which belongs to the first setting screen NS, and the second setting screen BS. Further, for example, "11" is set as the setting information for displaying, on the display section 13, a split setting screen SS2 (see FIG. 12) that splits display into a normal (non-transparent type) help screen NS3, which belongs to the first setting screen NS, and the second setting screen BS. The two bits of setting information specify the distinction between the full screen pattern and the split pattern and the distinction between the non transparent pattern and the transparent pattern.

The setting section 52 is referred to by the control section 50 that receives the first operation. In the setting section 52, one of the full screen display and the split screen display is set to be enabled. In a case where the full screen display is enabled, when the control section 50 receives the first operation while the second setting screen BS is displayed on the display section 13, the control section 50 switches the second setting screen BS to the first setting screen NS. In a case where the split screen display is enabled, when the first operation is received while the second setting screen BS is displayed on the display section 13, the control section 50 causes the second setting screen BS and the first setting screen NS to be displayed on the display section 13 simultaneously in a split manner.

The electronic device 11 includes an action section that performs an action of generating an image using the medium M (refer to FIG. 1). The image reading device 12, which is an example of the electronic device 11, includes a reading section 53, which is an example of an action section. The reading section 53 performs a reading operation to read an image of a document M1, which is an example of the medium M. Further, the image reading device 12 may further include a feed section 54 as an example of an action section. The feed section 54 performs a transport operation of transporting the medium M.

The electronic device 11 includes a computer (not shown). The computer includes a CPU and a first storage section 55. The control section 50 and the function control section 51 are not limited to those that perform software processes for all processes that they execute. For example, the control section 50 and the function control section 51 may include a dedicated hardware circuit (for example, an application specific integrated circuit: ASIC) that performs hardware processes for at least a part of the processes executed by the control section 50 and the function control section 51. That is, the control section 50 and the function control section 51 can be configured as a circuit including one or more processors that operate according to a computer program (software), one or more dedicated hardware circuits that execute at least a part of various processes, or a combination thereof. The processor includes a CPU and a storage section 55 (memory) such as a RAM and a ROM. The storage section 55 stores program code or instructions configured to cause the CPU to execute processes. The memory, that is, the computer-readable medium, includes any available medium that can be accessed by a general-purpose or dedicated computer.

The electronic device 11 includes a control section 50 and a function control section 51 as functional sections configured by software when the computer executes the first program PG1 stored in the storage section 55. The setting section 52 may be configured using a partial storage region of the storage section 55.

The control section 50 includes a switching display control section 60 and a split display control section 63. It should be noted that at least one of the switching display control section 60 and the split display control section 63 may include hardware such as an electronic circuit in a part thereof.

The switching display control section 60 includes a first display control section 61 and a second display control section 62. The switching display control section 60 has a function of switching the control subject of the display section 13 to one of the first display control section 61 and the second display control section 62. That is, the switching display control section 60 switches between the first setting screen and the second setting screen.

Based on the first display data D1, the first display control section 61 causes the display section 13 to display the first setting screen, which is one aspect of the setting screen. The setting screen functions as a user interface (UI) operated by user when the user gives an instruction to the electronic device 11. The first setting screen is displayed on the display section 13 based on the first display data D1 that the electronic device 11 has stored in the first storage section 55. The first setting screen is a native UI displayed on the display section 13 based on the first display data D1 that the electronic device manufacturer stored in the first storage section 55 in advance. Specifically, the first display control section 61 reads one piece of the first display data D1 to be displayed from the first storage section 55. Further, the first display control section 61 stores the read one piece of the first display data D1 in the display buffer 64 of the display drive circuit 56. Then, the display drive circuit 56 displays the first setting screen NS based on the first display data D1 stored in the display buffer 64 on the display section 13.

The second display control section 62 includes a browser. The second display control section 62 causes the browser to generate a second setting screen based on the second display data D2 received from the server 20. The second display control section 62 uses the browser function to display the second setting screen based on the second display data D2 on the display section 13. The second setting screen is displayed on the display section 13 based on the second display data D2 created by a vendor such as the IVS. The second setting screen is, for example, a browser UI. The second display control section 62 receives one piece of the second display data D2 received by the communication section 65 from the server 20 via the function control section 51. The second display control section 62 stores the received one piece of the second display data D2 in the display buffer 64 of the display drive circuit 56. The display drive circuit 56 causes the display section 13 to display the second setting screen BS based on the second display data D2 stored in the display buffer 64.

The split display control section 63 performs split display control to split and simultaneously display the first setting screen and the second setting screen on the display section 13. The split display control section 63 acquires the first display data D1 that is the source of the first setting screen and the second display data D2 that is the source of the second setting screen. The split display control section 63 acquires the first display data D1 from the first storage section 55 via the first display control section 61. The split display control section 63 acquires the second display data D2 from the server 20 via the function control section 51.

The split display control section 63 stores the first display data D1 in a part of the display buffer 64 and stores the second display data D2 in another part of the display buffer 64. The split display control section 63 may perform process treatment on the first display data D1 and the second display data D2. In this case, the display data that is the target of the process treatment may be at least one of the first display data D1 and the second display data D2.

### Electrical configuration of server 20

Next, configuration of the server 20 will be described. As illustrated in FIG. 2, the server 20 includes a server-side control section 21 (hereinafter also referred to simply as "control section 21”), the server-side display control section 22 (hereinafter, also simply referred to as "display control section 22”), a second split display control section 23, and a second storage section 24. The server 20 includes a communication section 25 that can communicate with the electronic device 11 via the network NW. The server 20 includes a computer. The second storage section 24 stores one or more pieces of second display data D2 capable of displaying a second setting screen BS, which is another display mode of the setting screen. The second storage section 24 stores a second program PG2. The server-side display control section 22 sends, to the electronic device 111, an instruction to display the second setting screen BS based on the second display data D2 on the display section 13 together with the second display data D2. The computer executes the second program PG2, thereby configuring the functions of the control section 21, the display control section 22, and the second split display control section 23.

The control section 21 performs authentication process and controls the electronic device 11. When the control section 21 receives the personal authentication information and the authentication request from the electronic device 11, the control section 21 requests the second server 30 (see FIG. 1) to perform an authentication process of the personal authentication information. When the personal authentication information is authenticated based on the authentication result information from the second server 30, the first server 20 permits the electronic device 11 to log in.

The second display data D2 and the second program PG2 are provided by a vendor, a manufacturer, or the like. An administrator such as a vendor or a manufacturer operates an input section 41 of the management computer 40 (see FIG. 1) to upload the second display data D2 and the second program PG2 from the management computer 40 to the first server 20. The uploaded second display data D2 and second program PG2 are stored in the second storage section 24. The second display data D2 and the second program PG2 stored in the second storage section 24 are updated regularly or irregularly by access from the management computer 40 to the first server 20.

The computer of the first server 20 executes the second program PG2. The control section 21, the display control section 22, and the second split display control section 23 are configured by software executed by a computer running the second program PG2.

The control section 21 controls the authenticated electronic device 11. The control section 21 controls, based on the second program PG2, the electronic device 11 from the server 20 through the network NW. The control section 21 performs control other than display control for displaying a setting screen or the like on the display section 13 of the electronic device 11.

The control section 21 gives an instruction to the electronic device 11. The instruction is transmitted from the server 20 to the electronic device 11 via the network NW. The instruction from the server 20 is received by the function control section 51 in the electronic device 11. The function control section 51 passes the instruction received from the server 20 to the control section 50. The control section 50 controls the electronic device 11 in accordance with the instruction received from the function control section 51. When the electronic device 11 is the image reading device 12, the control section 50, in accordance with the instruction received from the function control section 51, controls the actions of the reading section 53, the feed section 54, and the like, which are examples of the action section.

The display control section 22 controls display of the display section 13 from the server 20 through the network NW. The display control section 22 controls a setting screen or the like to be displayed on the display section 13 of the electronic device 11. The display control section 22 mainly controls display of a second setting screen including a browser UI.

The display control section 22 performs display control of the display section 13 by sending the second display data D2 and a display instruction to the electronic device 11. The display instruction includes an instruction to display, on the display section 13, the second setting screen based on the second display data D2. The display instruction and the second display data D2 from the server 20 are received by the function control section 51 in the electronic device 11. The function control section 51 passes the display-related instruction and the second display data D2 received from the server 20 to the second display control section 62 in the control section 50. The second display control section 62 controls the display section 13 based on the display-related instruction and the second display data D2 received from the function control section 51. That is, the second display control section 62 controls the display drive circuit 56 based on the display-related instruction and the second display data D2. The second display control section 62 stores, in accordance with an instruction from the display system, the second display data D2 in the display buffer 64 of the display drive circuit 56.

The second split display control section 23 gives a display instruction mainly related to split display control among display control of the display section 13 to the electronic device 11. The display instruction is transmitted from the server 20 to the electronic device 11 via the network NW. The display instruction from the server 20 is received by the function control section 51 in the electronic device 11. The display instruction includes, for example, a command related to the split display. The function control section 51 passes the display instruction to the split display control section 63 in the control section 50 according to the command in the display instruction received from the server 20. The split display control section 63 controls the split of the display section 13 in accordance with the display instruction received from the function control section 51. The split display control section 63 controls the display drive circuit 56 based on the display instruction received from the function control section 51. The split display control section 63 stores the first display data D1 in a part of the display buffer 64 of the display drive circuit 56 and stores the second display data D2 in another part of the display buffer 64 of the display drive circuit 56 based on the display instruction, thereby causing the display section 13 to display the second setting screen and the first setting screen in a split manner.

The server-side display control section 22 causes the display section 13 to display the second setting screen BS based on the second display data D2. When the second setting screen BS is displayed on the display section 13, the control section 50 of the electronic device 11 receives the first operation of selecting, by the operation section 14, the selected section in the second setting screen BS. Then, the server-side display control section 22 receives operation position information based on the first operation from the electronic device 11 via the network NW.

The second split display control section 23 sends, to the electronic device, a display instruction to cause the display section 13 to display the first setting screen NS based on the first display data D1 associated with the received operation position information. By giving the display instruction to the electronic device 11, the second split display control section 23 causes the control section 50 to simultaneously display, in a split manner on the display section 13, the second setting screen BS and the first setting screen NS based on the first display data D1 read from the first storage section 55.

### Second setting screen BS

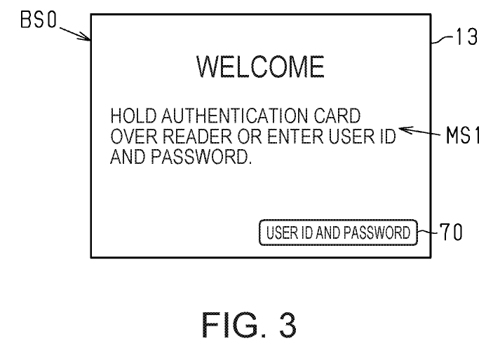

Next, the second setting screen BS will be described with reference to FIGS. 3 to 6.

FIG. 3 is a diagram illustrating an authentication screen BS0. The authentication screen BS0 includes a message MS1, which is information that prompts the user to perform personal verification, and an input field 70 for personal authentication information. The personal authentication information is input by inputting a user ID and a password to the input field 70 or by touching the authentication card 19 to the reader 18.

FIG. 4 is a home screen BS1. The home screen BS1 is displayed on the display section 13 when the certification is completed on the authentication screen BS0. The home screen BS1 includes a plurality of (for example, three) options 71 to 73 as a scan setting method to set the image reading conditions. That is, the home screen BS1 includes a first option 71 for selecting “standard scan", a second option 72 for selecting “scan", and a third option 73 for selecting "Favorites". The option 71 of “standard scan" is not present in the first setting screen, but is added to the home screen BS1 on the second setting screen side.

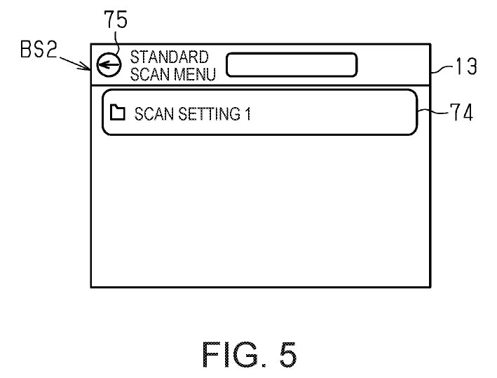

FIG. 5 illustrates a standard scan menu screen BS2. The standard scan menu screen BS2 is displayed on the display section 13 when the first option 71 is selected on the home screen BS1. The standard scan menu screen BS2 includes a selection button 74 that enables selection of a scan setting prepared as a standard scan on the server 20 side. A user who wants to use the standard scan performs an operation of selecting the selection button 74.

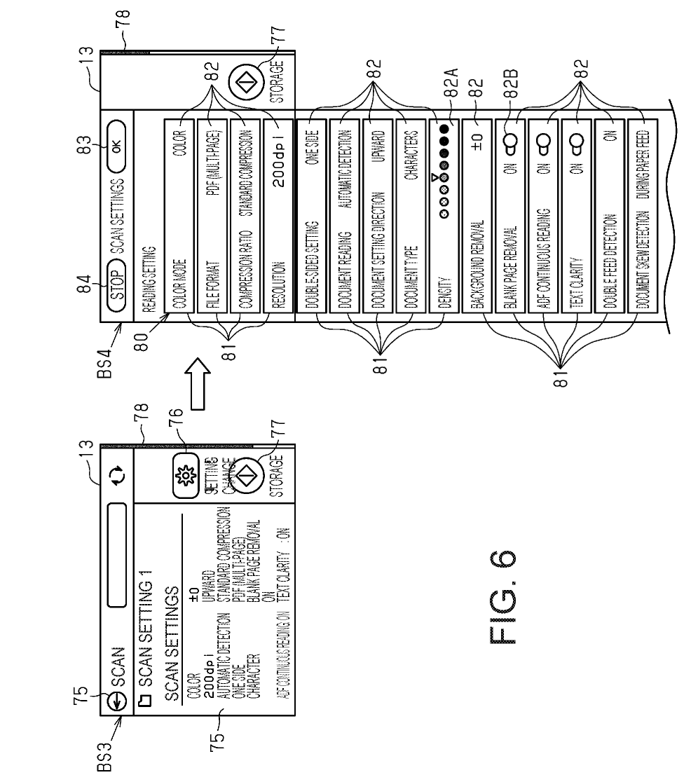

FIG. 6 illustrates a scan setting screen BS3 and a scan setting change screen BS4 (hereinafter also referred to as "setting change screen BS4”). The scan setting screen BS3 is displayed on the display section 13 when an operation of selecting the selection button 74 is performed on the standard scan menu screen BS2. The setting change screen BSb includes scan setting information 75, a setting change button 76, a save button 77, and a scroll bar 78. The scan setting information 75 is an information display field in which specific contents of the scan setting as the image reading conditions are shown. The scan setting information 75 includes setting items and setting contents (including setting values) for each of the setting items.

The setting change button 76 is a button to be selected by the user when changing the scan setting content. The save button 77 is a button operated by the user when the scan setting is updated by saving the changed setting content. The user who wants to change the setting contents after checking the scan setting information 75 performs an operation of selecting the setting change button 76. For example, when the user touches and selects the setting change button 76, a setting change screen BS4 is displayed on the display section 13.

The setting change screen BS4 illustrated in FIG. 6 includes a setting change list 80. The setting change list 80 includes a plurality of setting change options 81. The setting change options 81 are, for example, buttons for selecting reading conditions whose settings are to be changed by the user. The setting change options 81 are provided for each reading condition. The setting change options 81 include setting information 82 indicating the setting content of the reading conditions for each piece of reading conditions information. The setting change screen BS4 includes an OK button 83, a stop button 84, and a scroll bar 78. The OK button 83 is a button to be operated when the setting change is completed. When the OK button 83 is operated, the screen returns to the scan setting screen BS3 in a state where the setting change content is temporarily stored. When the stop button 84 is operated, the screen returns to the scan setting screen BS3 in a state where the setting change content is canceled.

In the setting change screen BS4 illustrated in FIG. 6, the user can visually check all of the plurality of setting change options 81 by operating the scroll bar 78 to scroll the screen. The plurality of setting change options 81 include the following reading conditions. That is, the reading conditions include image color modes (color/monochrome), file formats (PDF/JPEG/TIFF, and the like), compression ratio, resolutions (200/400/600dpi, and the like), reading surface setting (single-sided/double-sided), document reading (automatic detection/manual operation), document setting directions, document types, density, background removal, blank page removal, ADF continuous reading, text clarity, double feed detection, tilt detection, and the like.

As a means for changing the setting information 82, a method of displaying options in a pull-down manner when the setting information 82 is selected, a slider 82A, or a slider 82B for on/off switching may be provided.

### Help function and help Screen

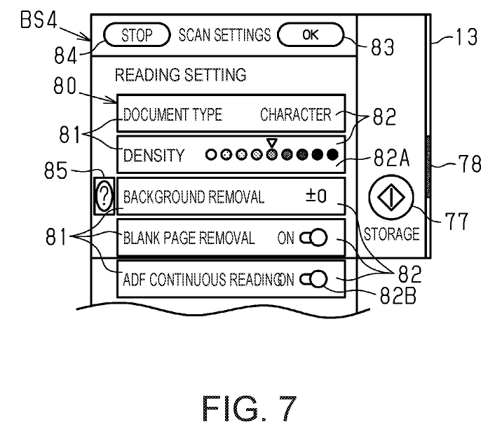

Next, help functions and help screens in the setting change screen BS4 will be described with reference to FIGS. 7 to 9. As illustrated in FIG. 7, the setting change screen BS4 includes a help icon 85 at a position corresponding to at least one setting change option 81. The help icon 85 is an icon that is selected when the user wants to see the description of the setting items of the reading conditions. In the example illustrated in FIG. 7, the help icon 85 is provided only for one setting item. The help icon 85 may be provided to all the setting items or may be provided to only some of the setting items. When the user selects the setting change options 81, the help icon 85 may be provided at a position corresponding to the setting change options 81 in the selected state. It should be noted that, in the present embodiment, the help icon 85 corresponds to an example of a selected section.

When the second setting screen BS is displayed on the display section 13, the control section 50 switches from the second setting screen BS to the first setting screen NS based on the one piece of the first display data D1 associated with the first operation upon receiving the first operation. Specifically, when the control section 50 receives the first operation in which the help icon 85 is selected, the control section 50 causes the display section 13 to display the help screen NS1 (FIG. 8) or the help screen NS2 (FIG. 9) in a display mode corresponding to the setting information set in the setting section 52. The help screens NS1 and NS2 belong to the first setting screen NS.

The help screen NS1 illustrated in FIG. 8 is displayed in a non transparent type full screen display mode. The help screen NS1 includes a message MS2 including a description of the setting item corresponding to the help icon 85. The help screen NS2 includes an OK button 86 and a close button 87.

The help screen NS2 illustrated in FIG. 9 is displayed in a transparent type full screen display mode. The help screen NS2 includes a message MS2 including a description of the setting item corresponding to the help icon 85. The help screen NS1 includes an OK button 86 and a close button 87.

When the OK button 86 is selected, the help screens NS1 and NS2 may be closed and switched to the original setting change screen BS4, or may be switched to an individual setting change screen corresponding to the setting item. When the OK button 86 is selected, an individual setting change screen corresponding to the setting item may be displayed in a split manner in a partial region of the help screens NS1 and NS2.

In the help screens NS1 and NS2 illustrated in FIGS. 8 and 9, the header region HA1 in a case where the close button 87 is removed may use a header area of a predetermined screen that belongs to the second setting screen BS. That is, the header region HA1 may be a part of a predetermined screen that belongs to the second setting screen BS.

### Split display

Next, with reference to FIGS. 10 to 12, a description will be given of a split setting screen in which the help screens NS1 and NS2, which belong to the first setting screen NS, are displayed in a split manner on the setting change screen BS4, which belongs to the second setting screen BS.

FIG. 10 illustrates a split setting screen SS1 in which the first setting screen NS and the second setting screen BS are split and displayed simultaneously. In the split setting screen SS1, the setting change screen BS4, which belongs to the second setting screen BS and which is the original screen, and the help screen NS2, which belongs to the first setting screen NS and which was added to the original screen, are displayed in a split manner. The help screen NS2 is a help individual display screen on which help information related to one setting item corresponding to the help icon 85 is individually displayed.

When the display section 13 performs the split display, the control section 50 splits the display region of the help screen NS2 into a size larger than the display region of the second setting screen BS. The display region of the help screen NS2 occupies a ratio exceeding 1/2 of the display region of the display section 13.

When the second setting screen BS is displayed, upon receiving the first operation of selecting the help icon 85, the control section 50 causes the display section 13 to simultaneously display, in a split manner, the second setting screen BS and the help screens NS2, NS3 as the first setting screen NS associated with the help icon 85. The first operation is an operation of selecting the help icon 85 in the second setting screen BS as the selected section.

The help screen NS2 includes an OK button 86 and a setting operation section 89. The OK button 86 has the same function as the OK button 86 of the help screens NS1 and NS2 displayed on the full screen display illustrated in FIGS. 8 and 9. The setting operation section 89 is configured to change the setting content related to the setting change options 81 corresponding to the help icon 85, which is an example of the selected section, selected by the first operation. The setting operation section 89 is, for example, a setting change button. The user can change the setting contents on the help screen NS2 that has confirmed the help information by operating the setting operation section 89 without operating the setting change screen BS4. When the control section 50 receives an operation of the setting operation section 89 on the help screen NS2, the control section 50 reflects the change of the setting content in the setting change options 81 corresponding to the help screen NS2.

In the split setting screen SS1, the display region per screen is reduced by the split display. The first display data D1 and the second display data D2 may be processed so that the first setting screen NS and the second setting screen BS are displayed in the reduced display region with as little omission of content as possible. In the example illustrated in FIG. 10, the two screens BS4 and NS2 displayed in a split manner may be subjected to image reduction processes at a ratio corresponding to respective display regions in the division direction (arrangement direction), or images of characters and component elements such as sliders 82A and 82B may be subjected to reduction processes in the division direction. Alternatively, the layout of the component elements in the two screens BS4 and NS2 displayed in a split manner may be changed in accordance with the size of the split display region.

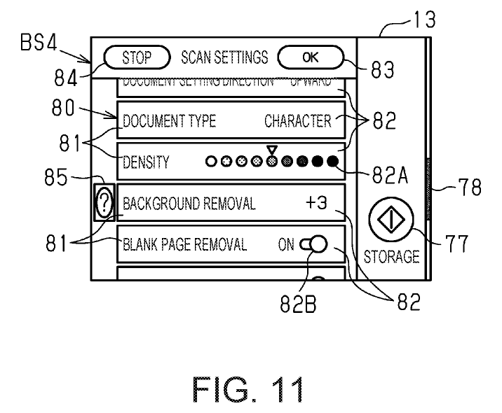

FIG. 11 is a setting change screen BS4 that is switched as a result of a setting change being performed on the split setting screen SS1. As illustrated in FIG. 11, the setting change screen BS4 reflects, for example, the setting change content in which the setting content of the setting item of "background removal" is changed from "0" to "+ 3".

FIG. 12 is a split setting screen SS2 in which the first setting screen NS and the second setting screen BS are displayed simultaneously in a split manner. The split setting screen SS2 is split into a setting change screen BS4, which belongs to the second setting screen BS, and a help screen NS3, which belongs to the first setting screen NS. The help screen NS3 is a help list display screen. When the display section 13 performs split display, the control section 50 splits the display region of the help screen NS3 into a size larger than the display region of the setting change screen BS4, which belongs to the second setting screen BS. The display region of the help screen NS3 occupies a ratio exceeding 1/2 of the display region of the display section 13.

In FIG. 12, the first setting screen NS added in association with the first operation is a help screen NS3, which is a help list display screen, including the help list 90. The help screen NS3 is a screen including the help list 90 in which a plurality of help options 91 are arranged and denoted with a title of help information for each setting item. When a desired one help option 91 is selected in the help screen NS3, the screen is switched to a split setting screen SS1 illustrated in FIG. 10 including an explanatory text related to the function of the setting item. It should be noted that, when a desired one help option 91 is selected in the help screen NS3, the help screen MS2 may be switched to the help screen NS2 illustrated in FIG. 8 or the help screen NS1 illustrated in FIG. 9, which include explanatory text related to the function of the setting item as a message MS2.

### Scroll operation on split screen

Next, with reference to FIGS. 10 and 12, a scroll operation on the split setting screens SS1 and SS2 will be described. There are the following three types of screen scroll operations when the user performs a scroll operation on the split setting screens SS1 and SS2. That is, a first scroll operation, a second scroll operation, and a third scroll operation. When the display section 13 is a touch panel that has the operation section 14 on the display screen, the scroll operation is performed by a touch operation (for example, a swipe) of the user. In the split setting screens SS1 and SS2, a scroll operation is performed on one of the setting change screen BS4, which belongs to the second setting screen BS, and the help screens NS2, NS3, which belong to the first setting screen NS.

### First scroll operation

When the scroll operation on the second setting screen BS is received, the control section 50 does not scroll the first setting screen NS even if the second setting screen BS is scrolled. In the split setting screen SS1 illustrated in FIG. 10, when the control section 50 receives a scroll operation on the setting change screen BS4, which belongs to the second setting screen BS, the control section 50 does not scroll the help screen NS2, which belongs to the first setting screen NS, even if the control section 50 scrolls the setting change screen BS4, which belongs to the second setting screen BS. In the split setting screen SS2 illustrated in FIG. 12, when the control section 50 receives a scroll operation on the setting change screen BS4, which belongs to the second setting screen BS, the control section 50 does not scroll the help screen NS3, which belongs to the first setting screen NS, even if the control section 50 scrolls the setting change screen BS4, which belongs to the second setting screen BS. Here, if the help screens NS2, NS3 are scrolled together with the setting change screen BS4, it is difficult to confirm the information of the help screens NS2, NS3. In the first scroll operation, the setting change screen BS4 can be operated while the help screens NS2, NS3 are being checked.

### Second scroll operation

When the scroll operation on the first setting screen NS is received, the control section 50 does not scroll the second setting screen BS even if the first setting screen NS is scrolled. In the split setting screen SS1 illustrated in FIG. 10, when the control section 50 receives a scroll operation on the help screen NS2, which belongs to the first setting screen NS, the control section 50 does not scroll the setting change screen BS4, which belongs to the second setting screen BS, even if the control section 50 scrolls the help screen NS2, which belongs to the first setting screen NS. In the split setting screen SS2 illustrated in FIG. 12, when the control section 50 receives a scroll operation on the help screen NS3, which belongs to the first setting screen NS, the control section 50 does not scroll the setting change screen BS4, which belongs to the second setting screen BS, even if the control section 50 scrolls the help screen NS3, which belongs to the first setting screen NS. In the second scroll operation, the help screens NS2, NS3 are scrolled while the display of the setting change screen BS4 remains unchanged, so that other information (for example, help information) can also be checked.

### Third scroll operation

When the control section 50 receives a scroll operation on one of the first setting screen NS and the second setting screen BS, the control section 50 scrolls both the first setting screen NS and the second setting screen BS. In the split setting screen SS1 illustrated in FIG. 10, when the control section 50 receives a scroll operation on one of the help screen NS2, which belongs to the first setting screen NS, and the setting change screen BS4, which belongs to the second setting screen BS, the control section 50 scrolls both the help screen NS2 and the setting change screen BS4. In this case, the help screen NS2 may be sequentially switched to the help screen NS2 corresponding to the next setting item by scrolling. In the split setting screen SS2 illustrated in FIG. 12, when the control section 50 receives a scroll operation on one of the help screen NS3, which belongs to the first setting screen NS, and the setting change screen BS4, which belongs to the second setting screen BS, the control section 50 scrolls both the help screen NS3 and the setting change screen BS4. In this case, even when the setting change screen BS4 is scrolled, the correspondence between the setting change options 81 on BS4 and the help options 91 on the help screen NS3 is maintained. In the third scroll operation, when the setting change screen BS4 is scrolled, the help screens NS2, NS3 are scrolled together, so that the trouble of searching for the help information of the help screens NS2, NS3 can be saved.

### Operation of first embodiment

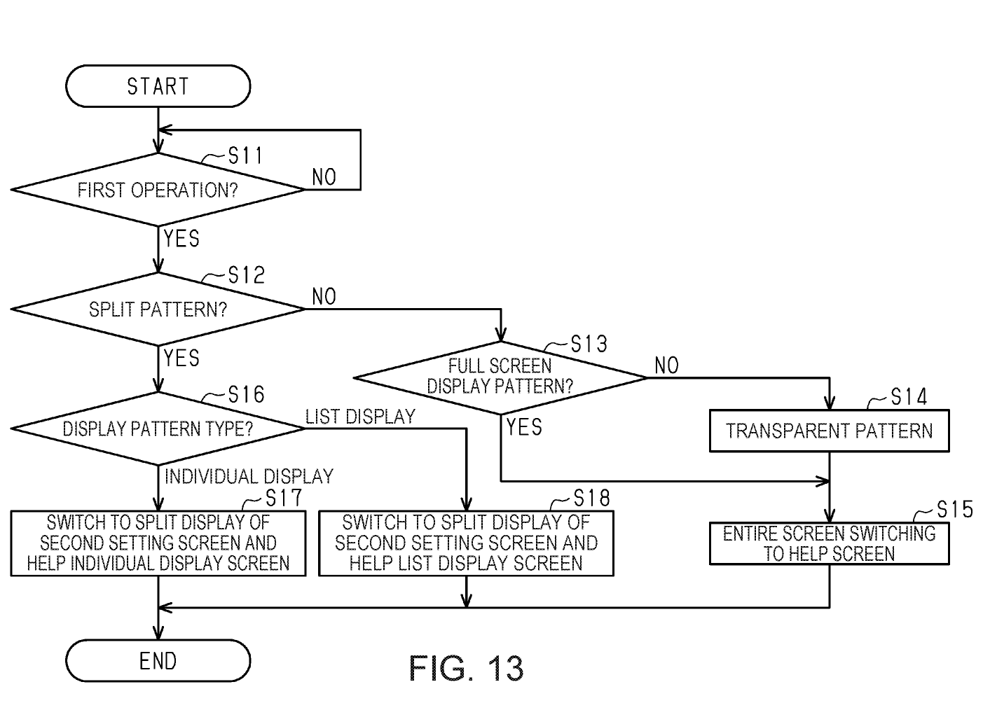

Next, the operation of the electronic device 11 and the display system 10 will be described with reference to FIGS. 13 to 15 and the like.

The user performs a first operation of selecting the help icon 85 on the setting change screen BS4 illustrated in FIG. 7, thereby displaying the help screen NS2 or NS3. The user proceeds with the setting change operation of the image reading conditions while reading the explanatory text related to the setting item indicated in the setting change options 81 and checking the function on the help screen NS2 or NS3. The processes executed by the control section 50 of the electronic device 11 in this process will be described below.

### Screen switching control routine

First, the screen switching control routine executed by the control section 50 that has detected the first operation will be described with reference to FIG. 13.

In step S11, the control section 50 determines whether or not the first operation is received. Specifically, it is determined whether or not the user is tapped the help icon 85. The control section 50 proceeds to step S12 when the first operation is performed, and waits until the first operation is performed when the first operation is not performed.

In step S12, the control section 50 determines whether or not the pattern is a split pattern. Specifically, the control section 50 determines whether or not the display mode set in the setting section 52 is the split pattern. The control section 50 proceeds to step S16 if the pattern is the split pattern, and proceeds to step S13 if the pattern is other than the split pattern.

In step S13, the control section 50 determines whether or not the display pattern is the full screen display pattern. The control section 50 proceeds to step S15 if the display pattern is the full screen display pattern, and proceeds to step S14 if the display pattern is not the full screen display pattern.

In step S14, the control section 50 determines the transparent pattern. That is, the control section 50 determines the transparent type full screen display pattern.

In step S15, the control section 50 switches the screen to the help screen. Specifically, when the full screen display pattern (YES in step S13) is set, the full screen is switched from the setting change screen BS4 illustrated in FIG. 7 to the non transparent type help screen NS1 illustrated in FIG. 8. On the other hand, when the transparent pattern (step S14) is set, the entire screen is switched from the setting change screen BS4 illustrated in FIG. 7 to the transparent type help screen NS2 illustrated in FIG. 9. In the help screen NS2, a part of the setting change screen BS4, which is the previous screen, is displayed in a transparent state in the transparent region 88.

On the other hand, in step S16, the control section 50 determines whether the display pattern is the individual display pattern or the list display pattern. The control section 50 proceeds to step S17 when the display pattern is the individual display pattern, and proceeds to step S18 when the display pattern is the list display pattern.

In step S17, the control section 50 switches to the split display in which the setting change screen BS4, which belongs to the second setting screen, and the help screen NS2, which is the help individual display screen, are simultaneously displayed. In step S18, the control section 50 switches to a split display in which the setting change screen BS4, which belongs to the second setting screen, and the help screen NS3, which is the help list display screen, are simultaneously displayed.

It should be noted that, in the processes from step S16 to step S18, the control section 50 notifies the server 20 of the first operation position information on the screen on which the first operation has been performed via the function control section 51 and the communication section 65, and receives a display instruction for instructing a display pattern as a response from the server 20. The control section 50 determines at step S16 the display pattern instructed by the received display instruction. The split display process including the communication process with the server 20 will be described in detail below.

### Split display control routine

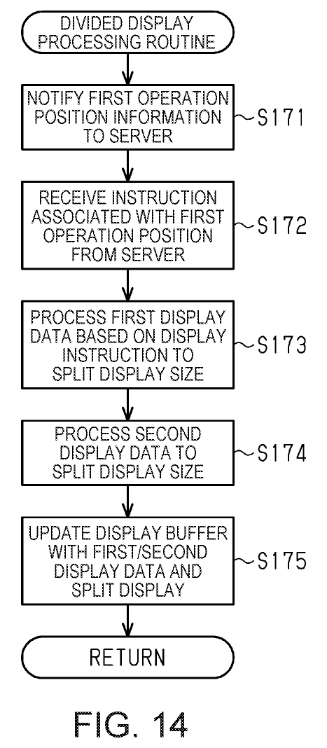

The split display process routine will be described with reference to FIG. 14. When performing the split display process during step S16 to step S18 in FIG. 13, the control section 50 executes the split display process illustrated in FIG. 14.

In step S171, the control section 50 notifies the server 20 of the first operation position information.

In the next step S172, the control section 50 receives a display instruction associated with the first operation position from the server 20.

In the next step S173, the control section 50 performs a process operation to convert the first display data D1 based on the display instruction into the split display size. The process treatment includes image compression processes (including reduction processes) and layout change processes. Omission of necessary information in the first display data D1 is to be avoided also in the display region when split display is performed by process treatment. It should be noted that some of the information in the first display data D1 that is not important may be omitted.

In step S174, the control section 50 processes the second display data D2 into the split display size. The process treatment includes image compression processes (including reduction processes) and layout change processes. Omission of necessary information in the second display data D2 is to be avoided also in the display region when split display is performed by process treatment. It should be noted that some of the information in the second display data D2 that is not important may be omitted.

In step S175, the control section 50 updates the display buffer 64 with the first display data D1 and the second display data D2, and displays the display buffer 64 on the display section 13 in split display. Specifically, the control section 50 updates a part of the display buffer 64 with the processed first display data D1 after process treatment, and updates another part of the display buffer 64 with the processed second display data D2 after process treatment. The display drive circuit 56 displays, on the display section 13, the setting change screen BS4 based on the first display data D1 stored in a part of the display buffer 64 and the help screen NS2 or NS3 based on the second display data D2 stored in another part of the display buffer 64. As a result, the display section 13 displays the split setting screen SS1 including the help screen NS2, which is the help individual display screen illustrated in FIG. 10, or the split setting screen SS2 including the help screen NS3, which is the help list display screen illustrated in FIG. 12.

### Touch display control routine

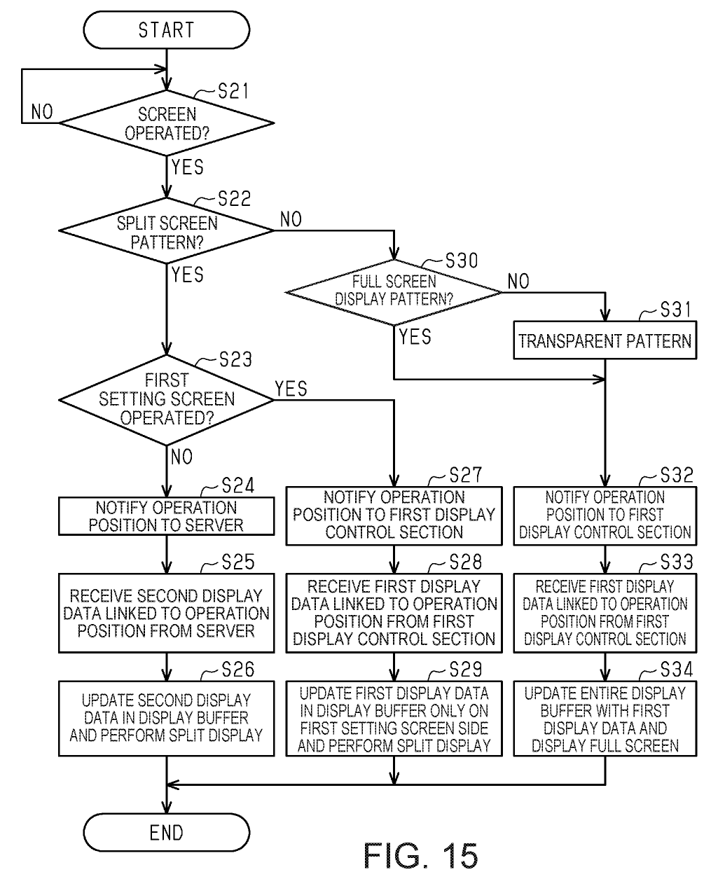

Next, with reference to FIG. 15, touch display control when the user touches the help screens NS1 and NS2 or the split setting screens SS1 and SS2 will be described. The user performs a screen operation such as a button operation or a scroll operation by touching the screen of the display section 13.

In step S21, the control section 50 determines whether or not a screen operation was performed. The control section 50 proceeds to step S22 if there is a screen operation, and waits until there is a screen operation if there is no screen operation.

The processes of steps S22, S30, and S31 are the same as the processes of steps S12, S13, and S14 in FIG. 13. By the processes of the steps S22, S30, and S31, it is determined whether the pattern is a split pattern (step S22), a full screen display pattern (step S30), or a transparent pattern (step S31). That is, the content of the touch control differs depending on whether the touch control is the split pattern or the full screen display pattern (non-transparent/transparent/transparent), and thus the pattern of the screen is determined. The control section 50 determines the pattern based on the setting information of the setting section 52.

In step S22, the control section 50 determines whether or not the pattern is the split pattern. If the pattern is the split pattern, the process proceeds to step S23, and if the pattern is other than the split pattern, the process proceeds to step S30. When a screen operation is performed on the split setting screen SS1 illustrated in FIG. 10 or the split setting screen SS2 illustrated in FIG. 12, the control section 50 determines that the split pattern is set based on the setting information of the setting section 52.

In step S23, the control section 50 determines whether or not the first setting screen NS was operated. The split setting screens SS1 and SS2 include a help screen NS2 or NS3, which belong to the first setting screen NS, and a setting change screen BS4, which belongs to the second setting screen BS. In this example, the control section 50 determines whether or not the help screen NS2 or NS3, which belong to the first setting screen NS, was operated. When the first setting screen NS is not operated, that is, when the second setting screen BS is operated, the control section 50 causes the process to proceed to step S24. On the other hand, the control section 50 causes the process to proceed to step S27 when the first setting screen NS is operated.

In step S24, the control section 50 notifies the server 20 of the operation position. Specifically, the split display control section 63 in the control section 50 acquires the operation position coordinates of the display screen from the operation signal from the operation section 14, and notifies the server 20 of the operation position coordinates as the operation position information via the function control section 51. Specifically, the function control section 51 calls the server 20 and transmits the operation position information acquired from the split display control section 63 to the server 20.

In step S25, the control section 50 acquires the second display data D2 associated with the first operation position from the server 20. In the server 20, the second split display control section 23 that received the first operation position information reads the second display data D2 associated with the first operation position information from the second storage section 24. The second split display control section 23 transmits, to the electronic device 11 as a response, the read second display data D2 and a display instruction to instruct display.

In the next step S26, the control section 50 updates the second display data D2 of the display buffer only on the second setting screen BS, and displays the second display data D2 on the display section 13 in a split display. By this process, the setting change screen BS4, which belongs to the second setting screen BS within the split setting screen SS1 or SS2, is updated according to the screen operation. In this way, for example, a scroll operation in the setting change screen BS4, a change operation of the setting information 82, a slide operation of the slider 82A or 82B, and the like are performed. When the scroll operation is performed at this time, the second scroll operation is performed. By this, even when the second setting screen BS is scrolled, the first setting screen NS is not scrolled.

On the other hand, in step S27, the control section 50 notifies the first display control section 61 of the operation position. Specifically, the split display control section 63 in the control section 50 acquires the operation position coordinates of the display screen from the operation signal from the operation section 14, and notifies the first display control section 61 of the operation position coordinates as operation position information.

In step S28, the control section 50 acquires the first display data D1 associated with the operation position from the first display control section 61. Specifically, the first display control section 61 reads the first display data D1 associated with the operation position information from the first storage section 55 and sends the first display data D1 to the split display control section 63. In this way, the split display control section 63 in the control section 50 acquires the first display data D1 associated with the operation position information.

In step S29, the control section 50 updates the first display data D1 of the display buffer only on the first setting screen NS side, and displays the screen on the display section 13 in split display. By this process, the help screens NS2 or NS3, which belong to the first setting screen NS within the division setting screens SS1 or SS2, is updated to the content according to the screen operation. In this way, for example, a button operation in the help screens NS2 or the NS3, a scroll operation of the help screen NS3, a selection operation of the help option 91, and the like are performed. When the scroll operation is performed at this time, the first scroll operation is performed. Therefore, even when the first setting screen NS is scrolled, the second setting screen BS is not scrolled. For example, the user can search for a desired help option 91 by scrolling the help screen NS3, which is the help list display screen in the split setting screen SS2 illustrated in FIG. 12. It should be noted that the first scroll operation is also performed on the help screen NS2, which is the help individual display screen in the split setting screen SS1 illustrated in FIG. 10.

When the screen operation is performed on the help screen NS1 illustrated in FIG. 8 or the help screen NS2 illustrated in FIG. 9, the control section 50 executes the processes of step S32 to step S34. Depending on whether the display pattern is the full screen display pattern or the transparent pattern, the help screen NS1 or the NS2 is displayed using the first display data D1 corresponding to the respective patterns. The other processes are the same.

In step S32, the control section 50 notifies the first display control section 61 of the operation position. Specifically, the switching display control section 60 in the control section 50 acquires the operation position coordinates of the display screen from the operation signal from the operation section 14, and notifies the first display control section 61 of the operation position coordinates as the operation position information.

In step S33, the control section 50 acquires the first display data D1 associated with the operation position from the first display control section 61. Specifically, the first display control section 61 that received the operation position information reads the first display data D1 associated with the operation position information from the first storage section 55.

In step S34, the control section 50 updates the entire surface of the display buffer 64 to the first display data D1, and displays the entire screen on the display section 13. By this process, the help screens NS1 or NS2 displayed on the entire screen is updated to the content corresponding to the screen operation. In this way, for example, a button operation of the OK button 86 or the like in the help screens NS1 or NS2 are performed. It should be noted that the help screens NS1 and NS2 displayed in full screen display may be configured for scroll operation. For example, the help screen may be switched to a help screen NS1 or NS2 for explaining the next setting item by a scroll operation.

The present embodiment configured as described above includes the following display control method of the electronic device 11. The display control method of the electronic device 11 includes the following (A1) and (A2).

(A1) When the second setting screen BS based on the second display data D2 is displayed on the display section 13, the first operation in which the selected section in the second setting screen BS is selected by the operation section 14 is received (affirmative determination in step S11).

(A2) When the first operation is received, the second setting screen BS and the first setting screen NS based on the first display data D1 associated with the first operation are displayed simultaneously on the display section 13 in split display (step S17 or step S18). The first setting screen NS is, for example, the help screen NS2 or NS3.

### Effects of first embodiment

According to the first embodiment, the following effects are obtained.

(1-1) The electronic device 11 includes an action section that performs an action to generate an image using the medium M. The electronic device 11 includes a display section 13, an operation section 14, a storage section 55, a communication section 65, and a control section 50. The display section 13 is configured to be able to display a setting screen that is visually checked by the user for setting image generation conditions, which are conditions for generating an image. The operation section 14 is configured to operate on the setting screen. The storage section 55 stores one or more pieces of first display data D1 configured to display a first setting screen NS, which is one display mode of the setting screen. The communication section 65 is configured to connect to a server via the network NW, the server storing one or more pieces of second display data D2 enabling display a second setting screen BS, which is another display mode of the setting screen. When the second setting screen BS based on the second display data D2 is displayed on the display section 13, the control section 50 receives a first operation in which the help icon 85, which is an example of a selected section in the second setting screen BS, is selected by the operation section 14. When the first operation is received, the control section 50 simultaneously displays the second setting screen BS and the first setting screen NS based on the one piece of the first display data D1 associated with the first operation on the display section 13 in a split manner. According to this configuration, even if the display content of the second setting screen BS is insufficient with respect to the display content of the first setting screen NS, the second setting screen BS and the first setting screen NS can be displayed simultaneously. The insufficiency in the second setting screen BS can be compensated by the first setting screen NS, and the second setting screen BS and the first setting screen NS can be visually checked simultaneously, so that the usability of the user is improved.

(1-2) Upon receiving the first operation while the second setting screen BS is displayed on the display section 13, the control section 50 switches from the second setting screen BS to the first setting screen NS based on one piece of the first display data D1 associated with the first operation. According to this configuration, even if the display content of the second setting screen BS is insufficient with respect to the display content of the first setting screen NS, the second setting screen BS can be switched to the first setting screen NS, and thus the insufficient portion of the second setting screen BS can be compensated by the first setting screen NS, and the usability of the user is improved.

(1-3) The electronic device 11 includes the setting section 52 that is referred to by the control section 50 that received the first operation and that enables one of the full screen display and the split screen display. In a case where the split screen display is enabled, when the first operation is received while the second setting screen BS is displayed on the display section 13, the control section 50 causes the second setting screen BS and the first setting screen NS to be displayed on the display section 13 simultaneously in a split manner. According to this configuration, even if the display content of the second setting screen BS is insufficient with respect to the display content of the first setting screen NS, the second setting screen BS and the first setting screen NS can be displayed simultaneously, and thus, the insufficient portion of the second setting screen BS can be compensated by the first setting screen NS, and the usability of the user is improved.

(1-4) The electronic device 11 includes the setting section 52 that is referred to by the control section 50, which received the first operation, and that enables one of the full screen display and the split screen display. In a case where the full screen display is enabled, when the control section 50 receives the first operation while the second setting screen BS is displayed on the display section 13, the control section 50 switches the second setting screen BS to the first setting screen NS. According to this configuration, even if the display content of the second setting screen BS is insufficient with respect to the display content of the first setting screen NS, the second setting screen BS can be switched to the first setting screen NS, and thus the insufficient portion of the second setting screen BS can be compensated by the first setting screen NS, and the usability of the user is improved.

(1-5) The first operation is an operation of selecting the help icon 85 in the second setting screen BS as the selected section. When the control section 50 receives selection of the help icon 85 while the second setting screen BS is displayed, the control section 50 causes the display section 13 to simultaneously display the second setting screen BS and help screens NS2, NS3 as the first setting screen NS associated with the help icon 85 in the split manner. According to this configuration, even if the second setting screen BS does not include the second display data D2 for the help screen, the help screens NS2, NS3 can be supplemented with the first display data D1 stored in the storage section 55 of the electronic device 11 side, and thus the usability of the user is improved.

(1-6) When the display section 13 displays in the split manner, the control section 50 splits the display region of the help screens NS2, NS3 into a size larger than the display region of the second setting screen BS. According to this configuration, the help screens NS2, NS3 are displayed in a large size, and thus the user can more easily confirm the content.

(1-7) When the control section 50 receives a scroll operation on the second setting screen BS, the control section 50 does not scroll the first setting screen NS even if the second setting screen BS is scrolled. According to this configuration, the second setting screen BS can be operated while referring the first setting screen NS (for example, the help screens NS2, NS3), and thus the usability of the user is good. If the first setting screen NS is scrolled together with the second setting screen BS, it is difficult to check the information of the first setting screen NS.

(1-8) When the control section 50 receives a scroll operation on the first setting screen NS, the control section 50 does not scroll the second setting screen BS even if the first setting screen NS is scrolled. According to this configuration, since the first setting screen NS (for example, the help screens NS2, NS3) can be scrolled and other information (for example, help information) can be referred while the display of the second setting screen BS is maintained, the usability for the user is good.

(1-9) When the control section 50 receives the scroll operation on one of the first setting screen NS and the second setting screen BS, the control section 50 scrolls both the first setting screen NS and the second setting screen BS. According to this configuration, since the first setting screen NS (for example, the help screens NS2, NS3) is also scrolled, it is possible to save time and effort to search for the information (for example, the help information) of the first setting screen NS, and the usability for the user is good.

(1-10) The help screens NS2, NS3 include the setting operation section 89 that is configured to change the setting content related to the setting change options 81 corresponding to the help icon 85, which is an example of the selected section, selected by the first operation. When the control section 50 receives a change of the setting content based on the operation of the setting operation section 89 on the help screens NS2, NS3, the control section 50 reflects the change of the setting content in the setting change options 81 on the second setting screen BS. According to this configuration, since the setting operation for changing the setting content can be performed on the help setting screen, the usability for the user is improved.

(1-11) The electronic device 11 is an image reading device including, as an action section, a reading section that reads a document as the medium M. According to this configuration, when the image generation conditions (image reading conditions) for reading the document and generating the image are set, the second setting screen BS and the first setting screen NS can be visually checked simultaneously so that the insufficiency in the second setting screen BS can be compensated by the first setting screen NS. Therefore, the usability of the user is improved.

(1-12) The server 20 is connected to the electronic device 11 via the network NW and is configured to control the display section 13 of the electronic device 11. The server includes a second storage section 24, a server-side display control section 22, and a second split display control section 23. The second storage section 24 stores one or more pieces of second display data D2 capable of displaying a second setting screen BS, which is another display mode of the setting screen. The server-side display control section 22 sends, to the electronic device 111, an instruction to display the second setting screen BS based on the second display data D2 on the display section 13 together with the second display data D2. When the second setting screen BS based on the second display data D2 is displayed on the display section 13, and the control section 50 of the electronic device 11 receives a first operation in which the help icon 85, which is an example of a selected section in the second setting screen BS, is selected by the operation section 14, the second split display control section 23 receives operation position information based on the first operation from the electronic device 11 via the network NW. The second split display control section 23 is configured to send, to the electronic device 11, a display instruction to cause the display section 13 to display the first setting screen NS based on the first display data D1 associated with the operation position information, so that the control section 50 displays, simultaneously on the display section 13 in a split manner, the second setting screen BS and the first setting screen NS based on the first display data D1 read from the storage section 55. According to this configuration, even if the display content of the second setting screen BS is insufficient with respect to the display content of the first setting screen NS, the second setting screen BS and the first setting screen NS can be displayed simultaneously. The insufficiency in the second setting screen BS can be compensated by the first setting screen NS, and the second setting screen BS and the first setting screen NS can be visually checked simultaneously, so that the usability of the user is improved.

(1-13) The display system includes the electronic device 11 and the server 20. According to this configuration, even if the display content of the second setting screen BS is insufficient with respect to the display content of the first setting screen NS, the second setting screen BS and the first setting screen NS can be displayed simultaneously. The insufficiency in the second setting screen BS can be compensated by the first setting screen NS, and the second setting screen BS and the first setting screen NS can be visually checked simultaneously, so that the usability of the user is improved.

(1-14) In a display control method of the electronic device 11 for controlling the display section 13 included in the electronic device 11, the electronic device 11 includes the action section, the display section 13, the operation section 14, the storage section 55, the communication section 65, and the control section 50. The action section performs actions to generate an image using the medium M. The display section 13 is configured to be able to display a setting screen that is visually checked by the user for setting image generation conditions, which are conditions for generating an image. The operation section 14 is configured to operate on the setting screen. The storage section 55 stores one or more pieces of first display data D1 configured to display a first setting screen NS, which is one display mode of the setting screen. The communication section 65 is configured to be connectable to the server 20 via the network NW. The server 20 stores one or more pieces of second display data D2 for displaying a second setting screen BS, which is another display mode of the setting screen.

The display control method of the electronic device 11 includes the following (A1) and (A2).

(A1) When the second setting screen BS based on the second display data D2 is displayed on the display section 13, the first operation of selecting the selected section in the second setting screen BS by the operation section 14 is received.

(A2) When the first operation is received, the second setting screen BS and the first setting screen NS based on the first display data D1 associated with the first operation are displayed on the display section 13 simultaneously in a split manner.

According to this method, even if the display content of the second setting screen BS is insufficient with respect to the display content of the first setting screen NS, the second setting screen BS and the first setting screen NS can be displayed simultaneously. The insufficiency in the second setting screen BS can be compensated by the first setting screen NS, and the second setting screen BS and the first setting screen NS can be visually checked simultaneously, so that the usability of the user is improved.

### Second Embodiment

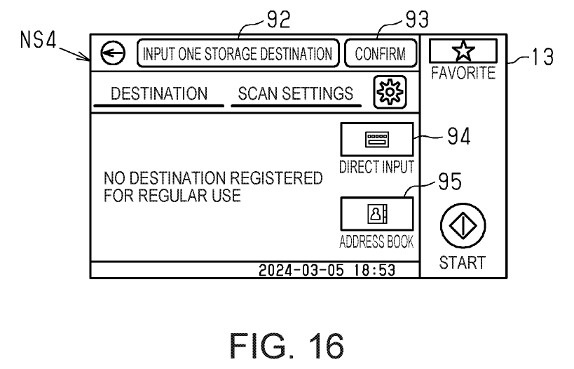

Next, a second embodiment will be described with reference to FIGS. 16 to 19. In the second embodiment, when the second operation selecting the selected section is received while the first setting screen NS is displayed on the display section 13, the second setting screen BS is added in a split display. The basic configurations of the electronic device 11 and the display system 10 are the same as those in the first embodiment. The contents of the first program PG1 illustrated in the flowcharts of FIGS. 13 to 15 are basically the same except that the display order of the first setting screen NS and the second setting screen BS is reversed.

The user logs in the electronic device 11 to the server 20 by performing an authentication process when using the electronic device 11. Therefore, the electronic device 11 displays the first setting screen NS based on the first display data D1 read from the first storage section 55 on the display section 13. In addition, the function control section 51 in the electronic device 11 is configured to call the server 20 and control the electronic device 11 under the control of the server 20. That is, the display section 13 of the electronic device 11 can perform the full screen display of the first setting screen NS based on the first display data D1, the full screen display of the second setting screen BS based on the second display data D2, and the split display in which the first setting screen NS and the second display data D2 are simultaneously displayed.

A home screen (not illustrated) that belongs to the first setting screen NS is displayed on the display section 13 of the electronic device 11. The home screen includes a plurality of icons for selecting a storage destination of the scan data. The plurality of icons can be selected as "computer", "network folder", "mail", and "cloud" as storage destinations. For example, when a press of the icon of "network folder" is received, the control section 50 causes the display section 13 to display a storage destination designation screen NS4 (storage destination selection screen), which belongs to the first setting screen NS illustrated in FIG. 16. The storage destination designation screen NS4 includes an input field 92 for entering a storage destination address, a confirm button 93 for determining a storage destination address, a direct input selection button 94, an address book selection button 95, and the like.

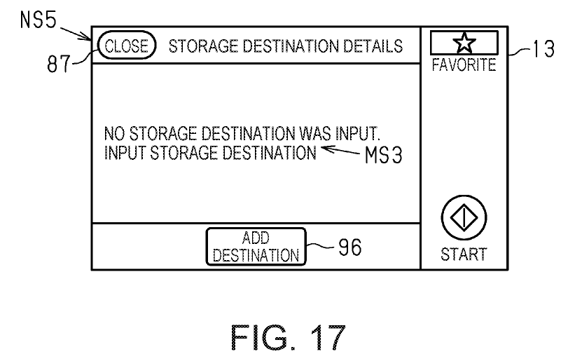

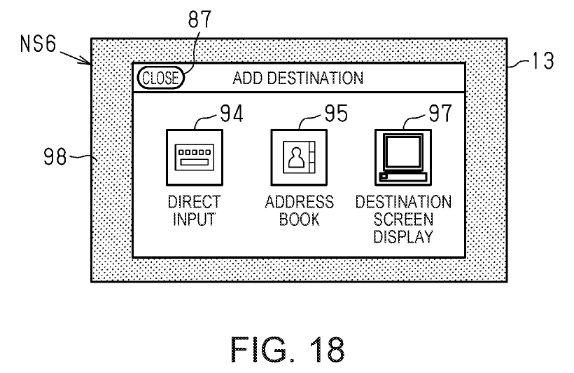

When the control section 50 receives a press of the confirm button 93 by the user in a state where the input field 92 of the storage destination designation screen NS4 illustrated in FIG. 16 is, for example, in a non-input state, the control section 50 causes the display section 13 to display a storage destination detail screen NS5 illustrated in FIG. 17. As a result, the display content of the display section 13 is switched from the storage destination designation screen NS4 to the storage destination detail screen NS5. The storage destination detail screen NS5 includes a message MS3 for prompting the user to input a storage destination and a destination addition button 96. When the control section 50 receives the pressing of the destination addition button 96 by the user, the control section 50 causes the display section 13 to display a storage destination designation screen NS6 (destination addition screen) illustrated in FIG. 18. The storage destination designation screen NS6 includes a direct input selection button 94, an address book selection button 95, and a destination screen display button 97.

In the present embodiment, the first setting screen NS including the selected section is the storage destination designation screen NS6 (FIG. 18). The storage destination designation screen NS6 includes a destination screen display button 97, which is an example of a storage destination designation portion, that can designate a storage destination for data (scan data) related to an image generated by the electronic device 11, as an example of a selected section. The storage destination designation screen NS6 has a transparent region 98 through which the background is transmitted in the peripheral edge portion.

In the second embodiment, the electronic device 11 includes the display section 13 that is configured to display the setting screen to be visually checked by the user in setting the image generation conditions, and the operation section 14 that is configured to perform the operation of selecting the selected section in the setting screen. Further, the electronic device 11 further includes the first storage section 55 that stores one or more pieces of first display data D1 to display the first setting screen NS, which is one display mode of the setting screen, and the communication section 65 that is connectable to the server 20 via the network NW, the server 20 storing one or more pieces of second display data D2 to display the second setting screen BS, which is another display mode of the setting screen.

The electronic device 11 is communicably connected to a terminal device 45 (see FIG. 1) connected to the server 20 via a network NW. The server 20 is also communicably connected to the terminal device 45 via the network NW. The server 20 is also accessible by the terminal device 45. The terminal device 45 has a folder designated by the user as a storage destination for the scan data read from the document M1 by the image reading device 12.

The screens NS4, NS5, and NS6 illustrated in FIGS. 16 to 18 all belong to the first setting screen NS. The first storage section 55 stores a plurality of first display data D1 to display each screen NS4, NS5, and NS6, which belong to the first setting screen NS.

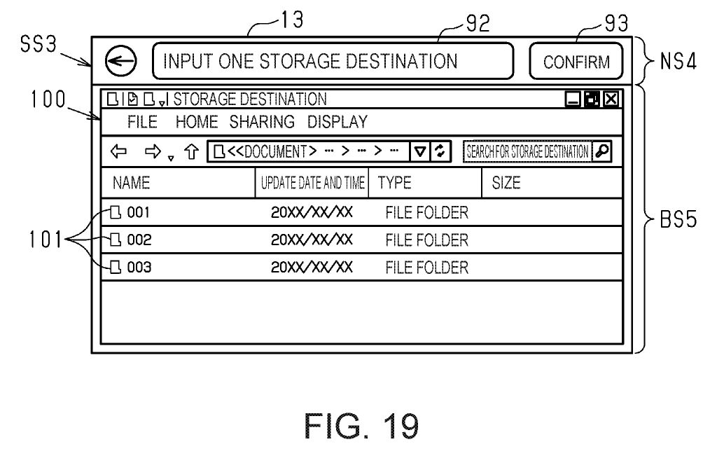

The control section 50 executes the first program PG1 stored in the first storage section 55 to display a split setting screen SS3 illustrated in FIG. 19 on the display section 13. Specifically, in the second embodiment, display control basically of the same type as the display control illustrated in the flowcharts of FIGS. 13 to 15 is executed. The second embodiment is different from the first embodiment in that, for example, in FIG. 13, the first operation is changed to the second operation and there is one type of split pattern, so that the processes of step S16 and step S18 are deleted. The second operation is an operation of selecting the destination screen display button 97, which is an example of the selected section, on the storage destination designation screen NS6, which belongs to the first setting screen NS. In the present embodiment, the first setting screen NS and the second setting screen BS displayed in a split manner in the step S17 are a part of the storage destination designation screen NS4 (FIG. 16) and the folder selection screen BS5. In this way, only a part of the first setting screen NS to be displayed in a split manner may be displayed.

For example, the user performs the second operation of pressing the destination screen display button 97, which is an example of the selected section, on the storage destination designation screen NS6 illustrated in FIG. 18. When the storage destination designation screen D1, which belongs to the first setting screen NS, is displayed on the display section 13 based on the first display data D1, the control section 50 receives a second operation in which the destination screen display button 97 in the storage destination designation screen NS6 is selected by the operation section 14. When the second operation is received, the control section 50 sends second operation position information indicating the operation position of the second operation to the server 20, and causes the display section 13 to simultaneously display, in a split manner, the first setting screen NS and the second setting screen BS based on the second display data D2 received from the server 20 as a response to the second operation position information. That is, when the control section 50 receives the second operation in which the destination screen display button 97 is selected, the control section 50 causes the display section 13 to display the split setting screen SS3 illustrated in FIG. 19 using the second display data D2 received from the server 20 as a response to the transmission of the second operation position information related to the second operation. The split setting screen SS3 includes a storage destination designation screen NS4, which belongs to the first setting screen NS, and a folder list screen 100 based on a new second display data D2 acquired by the server 20 from the terminal device 45. Specifically, the control section 50 splits the storage destination designation screen NS4 after the process treatment and the folder selection screen BS5 including the folder list screen 100 and simultaneously displays the split screens on the display section 13. The split setting screen SS3 includes a storage destination designation screen NS4 and a folder selection screen BS5 after the cutting out as an example of the process treatment. The folder list screen 100 includes a plurality of folders 101 that can be selected by the user.

The server 20 of the second embodiment has the following features in its configuration. The server 20 includes the server-side display control section 22 and the second storage section 24, similarly to in the first embodiment. Further, the server 20 includes the second split display control section 23 that receives the second operation position information from the electronic device 11 via the network NW.

The second split display control section 23 performs an image acquisition process associated with the second operation position information and, before performing the image acquisition process, obtains a new second display data D2 different from the second display data D2 stored in the second storage section 24. The second split display control section 23 sends, to the electronic device 11, the new second display data D2 and a display instruction to cause the display section 13 to display the second setting screen BS based on the new second display data D2. By this, the second split display control section 23 causes the control section 50 of the electronic device 11 to simultaneously display, in a split manner, the first setting screen NS and the second setting screen BS based on the new second display data D2 on the display section 13. As an example of the image acquisition process associated with the second operation position information, the second split display control section 23 accesses the terminal device 45 via the network NW and acquires a folder list image of the terminal device 45. The second split display control section 23 sets the acquired folder list image as a new second display data D2, for example, in a format that can be handled by the browser of the second display control section 62.

In the second embodiment, the first setting screen NS to be displayed in a split manner is the storage destination designation screen NS6 different from the storage destination designation screen NS4 having the destination screen display button 97, which is an example of the selected section. As described above, the storage destination designation screen NS6 that has the selected section and the storage destination designation screen NS4 to be displayed in a split manner may be different from each other as long as both belong to the first setting screen NS.

The split display process routine of the second embodiment is different from that of the first embodiment illustrated in FIG. 14 in the following points. One is that the first operation position information is changed to the second operation position information that is the position coordinates on the screen where the second operation is performed, and the other is that the second display data D2 associated with the second operation position is received from the server 20 together with the display instruction in step S172. The second split display control section 23 in the server 20 communicates with the terminal device 45 based on the address information acquired from the electronic device 11 or the terminal device 45, and requests the terminal device 45 to provide the folder list image. The second split display control section 23 acquires the folder list image from the terminal device 45 as a response to the request. The second split display control section 23 transmits the folder list image acquired from the terminal device 45, as the second display data D2 that can be handled by the browser, to the electronic device 11 together with the display instruction. Step S172 is changed to a process in which the control section 50 receives a display instruction together with the second display data D2 including the folder list image associated with the second operation position information from the server 20. Step S173 is changed to process treatment in which the control section 50 processes the second display data D2 based on the display instruction into the split display size. Step S174 is changed to a process treatment in which the control section 50 processes the first display data D1 into the split display size. It should be noted that, in the second embodiment, since a part of the first setting screen NS to be displayed in a split manner is used or the second setting screen BS is newly generated, the process treatment may be a process of cutting a part of the first display data D1 or a process of adjusting the size of the second display data D2 to a predetermined display size. In this way, the split display control section 63 in the control section 50 updates the display buffer 64 with a part of the first display data D1and the second display data D2, thereby performing split display on the display section 13 (step S175).

In the second embodiment, the display control when the user performs the touch operation on the split setting screen SS3 or the like is performed by the control section 50 executing the touch display control routine illustrated in FIG. 15, which is the same as that of the first embodiment. For example, when the folder list screen 100 is larger than the display region in the split setting screen SS3, the entire folder list screen 100 may be visually checked by a scroll operation.

The display control method of the electronic device 11 in the second embodiment includes the following (B1) and (B2).

(B1) When the first setting screen NS based on the first display data D1 is displayed on the display section 13, and a second operation in which a selected section in the first setting screen NS is selected by the operation section 14 is received, the control section sends second operation position information that indicates an operation position of the second operation to the server 20, (B2) simultaneously displays, in a split manner, the first setting screen NS and the second setting screen BS based on the second display data D2 received from the server 20 as a response to the second operation position information on the display section 13.

### Effects of Second Embodiment

According to the electronic device 11 and the display system 10 of the second embodiment, although the first operation in the first embodiment is changed to the second operation, the following effects are further obtained in addition to the same effects as the effects (1-3) to (1-13) obtained in the first embodiment.

(2-1) The electronic device 11 includes an action section that performs an action to generate an image using the medium M. The electronic device 11 includes a display section 13, an operation section 14, a storage section 55, a communication section 65, and a control section 50. The display section 13 is configured to be able to display a setting screen that is visually checked by the user for setting image generation conditions, which are conditions for generating an image. The operation section 14 is configured to operate on the setting screen. The storage section 55 stores one or more pieces of first display data D1 configured to display a first setting screen NS, which is one display mode of the setting screen. The communication section 65 is configured to be connectable to the server 20 via the network NW. The server 20 stores one or more pieces of second display data D2 for displaying a second setting screen BS, which is another display mode of the setting screen. When the storage destination designation screen D1, which belongs to the first setting screen NS, is displayed on the display section 13 based on the first display data D1, the control section 50 receives a second operation in which the destination screen display button 97 in the storage destination designation screen NS6 is selected by the operation section 14. When the second operation is received, the control section 50 sends second operation position information indicating the operation position of the second operation to the server 20, and causes the display section 13 to simultaneously display, in a split manner, the first setting screen NS and the second setting screen BS based on the second display data D2 received from the server 20 as a response to the second operation position information. According to this configuration, the display content that cannot be displayed on the first setting screen NS can be supplemented by the second setting screen BS, and the usability for the user is improved. For example, the user-specific display content or the like that cannot be prepared as the first setting screen NS is split and simultaneously displayed on the display section 13 as the second setting screen BS, thereby improving the usability for the user.

(2-2) The electronic device 11 is communicably connected to the terminal device 45 connected to the server 20 via the network NW. The first setting screen NS is a storage destination designation screen NS6 including, as a selected section, a destination screen display button 97, which is an example of a storage destination designation portion, that is configured to designate a storage destination of an image generated by the electronic device 11. When the control section 50 receives a second operation of selecting the destination screen display button 97 in the storage destination designation screen NS6, the control section 50 simultaneously displays, in a split manner, the storage destination designation screen NS4 and the folder list screen 100 received from the terminal device via the server 20 on the display section 13. According to this configuration, even if the display content of the storage destination designation screen NS4 as the first setting screen NS is insufficient for the display content that can be displayed as the second setting screen BS, the storage destination designation screen NS4 and the folder list screen 100 received from the terminal device 45 via the server 20 can be displayed simultaneously by splitting the display section 13. Therefore, the user's convenience is improved by simultaneously displaying the storage destination designation screen NS4 and the folder list screen 100 of the terminal device 45.

(2-3) The server 20 includes the second split display control section 23 that receives the second operation position information from the electronic device 11 via the network NW. The second split display control section 23 performs an image acquisition process associated with the second operation position information and, before performing the image acquisition process, obtains a new second display data D2 different from the second display data D2 stored in the second storage section 24. The second split display control section 23 sends, to the electronic device 11, the new second display data D2 and a display instruction to cause the display section 13 to display the second setting screen BS based on the new second display data D2. By this, the second split display control section 23 causes the control section 50 of the electronic device 11 to simultaneously display, in a split manner, the first setting screen NS and the second setting screen BS based on the new second display data D2 on the display section 13. According to this configuration, by the server 20, among the first setting screen NS and the second setting screen BS in the electronic device 11, an incompatibility of one (for example, the first setting screen NS) can be compensated by the other (for example, the second setting screen BS), and the first setting screen NS and the second setting screen BS can be visually checked at the same time. Therefore, the usability of the user is improved.

### Modifications

It should be noted that the above embodiment may be modified as shown in the following modifications. Further, a combination of the above-described embodiment and the following modifications may be a further modification, and a combination of the following modification may be a further modification.

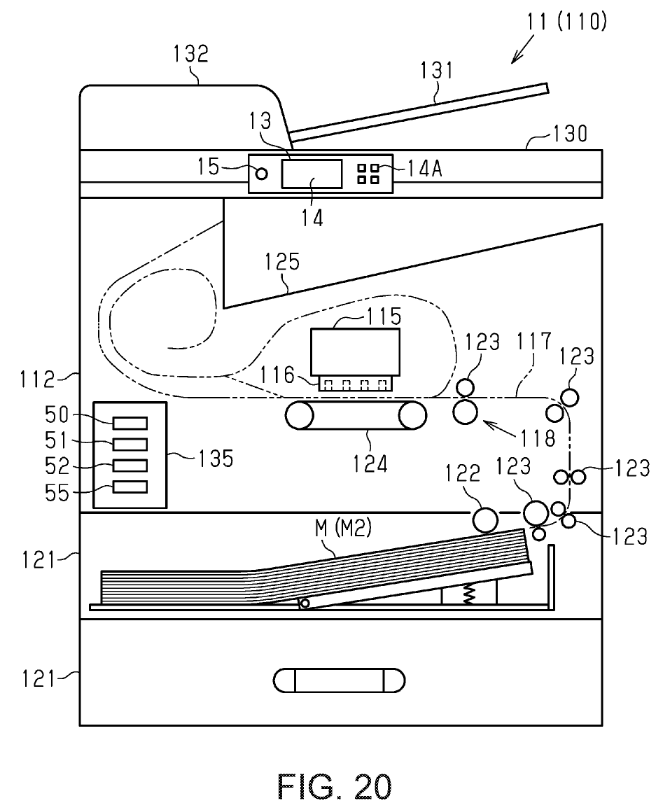

As illustrated in FIG. 20, the electronic device 11 may be an image forming device 110. The image forming device 110 includes an image forming section that forms an image on a medium M as an action section. The image forming device 110 forms an image using a medium M. The image forming device 110 may be, for example, an ink jet printer. The image forming device 110 includes a display section 13 on an upper portion of a main body 112. The display section 13 may be configured by, for example, a touch panel. In this case, the operation section 14 may be configured to allow input by a touch operation on the display screen by a touch panel function of the display section 13. The operation section 14 may include the operation section 14A including a mechanical switch in at least a part thereof. The image forming device 110 may include a power button 15 at a position near the display section 13. The image forming device 110, which is an example of the electronic device 11, forms an image using the medium M, as in the first embodiment. The image forming device 110 includes an image forming section 115 that forms an image on the medium M. The image forming section 115 includes, for example, an ejection head 116 that ejects ink. The image forming section 115 prints an image on the medium M transported along a transport path 117 in the main body 112. That is, the image forming device 110 forms an image on the medium M by printing. The image forming device 110, which is an ink jet printer, is also a liquid ejecting device that ejects ink, which is an example of a recording material, toward a medium M. The medium M is, for example, paper sheets M2. One or more cassettes 121 are detachably inserted into a lower portion of the main body 112. In the cassette 121, plural sheets of medium M are accommodated in a stacked state. The image forming device 110 includes a feed section 118 that transports the medium M along a transport path 117 in a main body 112. The feed section 118 includes a plurality of rollers 122 and 123 and a transport belt 124 disposed at positions along the transport path 117. The feed section 118 transports the medium M in the cassette 121 one sheet at a time along the transport path 117 by the plurality of rollers 122 and 123 and the transport belt 124. The image forming section 115 forms an image on the medium M at an image forming position in the middle of the transport path 117. The medium M on which the image is formed is discharged to a stacker 125 provided in an upper portion of the main body 112. As illustrated in FIG. 20, the image forming device 110 may be a multifunction device including an image reading device 130 on the upper portion of a main body 112. The image reading device 130 includes a feed tray 131 on which a document can be placed, and an automatic feeding device 132 (ADF) that transports the document on the feed tray 131 one sheet at a time. A control box 135 that controls the image forming device 110 is disposed at a predetermined position in the main body 112. The control box 135 includes a control section 50, a function control section 51, a setting section 52, and a storage section 55, as in the first embodiment. The storage section 55 stores the first program PG1 and the first display data D1, as in the first embodiment. The image forming device 110 includes a communication interface (not illustrated) that is communicably connected to the server 20 that stores the second display data D2 via the network NW. The control section 50 executes display control of the display section 13 in the same manner as in the first embodiment. The image generation conditions, which are conditions for generating an image, are, for example, printing conditions. The control section 50 causes the display section 13 to display a setting screen that is visually checked by the user in setting the printing conditions. The control section 50 executes a first program PG1 illustrated in the flowcharts in FIGS. 13 to 15. The control section 50 causes the display section 13 to display the screens illustrated in FIGS. 7 to 12 in which the reading conditions in the first embodiment are replaced with the printing conditions. The control section 50, for example, causes the display section 13 to display the divided screen to be visually checked by the user in setting the printing conditions in a display mode corresponding to the split setting screen SS1 illustrated in FIG. 10 or the split setting screen SS2 illustrated in FIG. 12. According to the image forming device 110, when the image forming conditions (an example of the image generation conditions) for forming an image on the medium M are set, the second setting screen BS and the first setting screen NS can be visually checked at the same time, and thus, an insufficiency in the second setting screen BS can be compensated by the first setting screen NS. Therefore, the usability of the user is improved.

The header region in the setting screen before the split display may be common to the split setting screens SS1 and SS2.

In the first embodiment, in the second setting screen BS in the full screen display, at least one of the header region and the footer region of the first setting screen NS may be used in common. In the second embodiment, at least one of the header region and the footer region of the second setting screen BS may be used in common in the first setting screen NS in the full screen display. That is, in each of the embodiments, the header region or the footer region may be commonly used in the first setting screen NS and the second setting screen BS in the full screen display. For example, the header region may be common to the second setting screen BS and the first setting screen NS in the full screen display. The first setting screen NS and the second setting screen BS in the full screen display may have a common footer region. Further, the first setting screen NS and the second setting screen BS in the full screen display may share the header region and the footer region.

In the split display, the help screens NS2, NS3, which are examples of the first setting screen NS associated with the first operation, may commonly use at least one of the header region and the footer region of the second setting screen BS before the split display. In this case, the help screen may display the first setting screen NS in a display region other than at least one of the header region and the footer region. For example, in the split setting screen SS1 illustrated in FIG. 10, a horizontally long rectangular region including the close button 87 located in the upper portion of the help screen NS2 may be used as the header region of the second setting screen BS. In the split setting screen SS2 illustrated in FIG. 12, the header region, which is a horizontally elongated rectangular region, including the title of the list located in the upper portion of the help screen NS3, may use the header region of the second setting screen BS.

In the split setting screens SS1 and SS2, the display size of the help screens NS2, NS3, which are examples of the first setting screen NS, may be the same as the display size of the setting change screen BS4, which is an example of the second setting screen BS, or may be smaller than the display size of the setting change screen BS4. The display size of the help screens NS2, NS3 may be 1/2 or less than 1/2 of the display region of the display section 13.

The selected section is not limited to the help icon 85 and the destination screen display button 97. The selected section may be a button or the like to display a setting screen of a lower hierarchy. The options to be selected in the second operation are not limited to the destination screen display button 97, and may be another button.

In the second embodiment, the storage destination designation screen NS4 (FIG. 16) may include the destination screen display button 97, which is an example of the selected section. The storage destination designation screen NS6 (FIG. 18) may include the confirm button 93. In these cases, the first setting screen NS that has the selected section and the first setting screen NS displayed in a split manner may be the same save destination designation screens NS4 or NS6.

In the second embodiment, the split setting screen SS3 may be a screen that displays the first setting screen NS having the selected section and the second setting screen BS in a split manner. That is, the first setting screen NS that has the selected section selected in the second operation may be the same as the first setting screen NS to be displayed in a split manner. The entire first setting screen NS, which is to be displayed in a split manner, may be displayed on the split setting screen SS3.

The process treatment performed on at least one of the first setting screen NS and the second setting screen BS displayed on any of the division setting screens SS1 to SS3 may include at least one of reduction, enlargement, cutting out, partial deletion, deformation, rotation, and the like.

At least one of the first setting screen NS and the second setting screen BS displayed on any of the division setting screens SS1 to SS3 may not be subjected to the process treatment such as the reduction process in one direction or in size. For example, both the first setting screen NS and the second setting screen BS may not be subjected to the process treatment.

The total number of the first setting screen NS and the second setting screen BS displayed on any of the division setting screens SS1 to SS3 is not limited to two, and may be three or more. The first setting screen NS and the second setting screen BS that are three or more in total may be displayed on the display section 13 in a manner split into three or more.

The electronic device 11 may not include the feed section 54 that transports the medium M to generate an image. The electronic device 11 may be a flatbed type image reading device 12 that does not include a feed section, or may be an image forming device 110 that does not include the feed section 118. The image forming device 110 that does not include the feed section 118 forms an image on the medium M by moving the image forming section 115 relative to the medium M placed on the table.

In the first and second embodiments, the electronic device 11 is not limited to the sheet feed system image reading device 12, and may be a flatbed type image reading device 12. The flatbed image reading device 12 includes a carriage that is movable along the sub-scanning direction and supports the reading section 533 in a main body constituting a document base to which a document cover is attached so as to be openable and closable. The carriage reciprocates in the sub-scanning direction using a motor as a power source, and, by this, the reading section 53 reads an image of the document M1 set on the glass plate of the document base.

The image forming device 110, which is an example of the electronic device 11, is not limited to the multifunction device illustrated in FIG. 20, and may be a printing device that does not include the image reading device 130.

The image forming device 110, which is an example of the electronic device 11, is not limited to a business printer used in an office or the like, and may be a so-called consumer printer used as a home printer in a home or the like. The image forming device 110 may be a line printer that has the image forming section 115 is a line head, or may be a serial printer that has the image forming section 115 is a serial head. Further, the image forming device 110 is not limited to an ink jet printer, and may be an electrophotographic system printer such as a laser printer that prints on the medium M using toner as ink. The image forming device may be a textile printer that performs printing on the medium M that is a fabric, or a printer that performs printing on a material such as a T-shirt as the medium M. The image forming device may be a printer that prints, as the medium M, a transfer film to which an image can be transferred by a direct to film (DTF) method.

In the first and second embodiments, at least one of the first setting screen NS and the second setting screen BS constituting the split setting screens SS1 to SS3 may be scrolled by the operation section 14A including a mechanical switch.

The operation section 14, through which the user performs an operation on the setting screen displayed on the display section 13, is not limited to the touch panel function of the display section 13. The operation section 14 may be able to use both the touch panel function of the display section 13 and the operation section 14A including a mechanical switch.

Each functional section included in the electronic device 11 is not limited to being realized by the CPU of the computer, and may be realized by hardware by an electronic circuit such as an application specific integrated circuit (ASIC) and a field-programmable gate array (FPGA), or may be realized by both software and hardware.

The medium is not limited to paper such as a document or a paper sheet, and may be a resin film or sheet, a woven fabric, a metal film, or the like.

The electronic device 11 is not limited to the image reading device 12 or the image forming device 110 as long as the electronic device 11 is a device including an image generation function to generate an image using a medium, the display section 13, and the communication section 65 that is configured to communicate with the server 20. The electronic device 11 may be a projector that generates an image on a screen by projecting the image using the screen, which is an example of a medium. In this case, the screen may be a white wall. The electronic device 11 may be a 3D printer (three dimensional image forming device) that forms a three dimensional object by stacking image layers, onto which droplets that contains ultraviolet curable resins are discharged, on a substrate sheet, which is an example of medium.

The electronic device 11 does not have an image generation function to generate an image using a medium, and may include the display section 13 that is configured to display setting screen to be visually checked by the user in the setting of setting conditions to operate an action section that performs a predetermined action, the function control section 51, and a communication section configured to communicate with the server 20. The electronic device 11 may be a white board device that has an electronic blackboard function, an output device such as a digital signage, an image pickup device such as a digital camera, an acoustic device, a sound collecting device, a medical device, a network household appliance, an industrial machine, a manufacturing device, or the like.

### Definitions

The phrase "at least one" as used herein means "one or more" of the desired options. As an example, the expression "at least one" used in the present specification means "only one option" or "both of two options" when the number of options is two. As another example, the expression "at least one" used in the present specification means "only one option" or "a combination of two or more arbitrary options" when the number of options is three or more.

### Technical Ideas

Hereinafter, technical ideas grasped from the embodiment and the modifications will be described together with effects.

(1) An electronic device includes an action section that performs an action to generate an image using a medium, the electronic device including a display section configured to display a setting screen that is to be visually checked by a user after setting an image generation condition, which is a condition for generating the image; an operation section configured to enable an operation on the setting screen; a storage section configured to store one or more pieces of first display data to display a first setting screen, which is one display mode of the setting screen; a communication section connectable via a network to a server storing one or more pieces of second display data that enables display of a second setting screen, which is another display mode of the setting screen; and a control section configured to, when a first operation of selecting a selected section in the second setting screen is received by the operation section while the second setting screen based on the second display data is being displayed on the display section, cause the display section to simultaneously display, in a split manner, the second setting screen and the first setting screen, which is based on one piece of first display data associated with the first operation.

According to this configuration, any sections not covered by one of the first setting screen and the second setting screen can be compensated by the other, and the first setting screen and the second setting screen can be visually checked at the same time. Therefore, the usability of the user is improved.

(2) The electronic device according to (1) may be such that the control section is configured to, when the first operation is received while the second setting screen is being displayed on the display section, switch from the second setting screen to the first setting screen, which is based on the one piece of the first display data associated with the first operation. According to this configuration, any sections not covered by one of the first setting screen and the second setting screen can be compensated by the other, and the first setting screen and the second setting screen can be visually checked at the same time. Therefore, the usability of the user is improved.

(3) The electronic device according to (1) or (2) may further include a setting section that is referred to by the control section that received the first operation and that sets one of a full screen display and a split screen display to be enabled, wherein in a case where the split screen display is enabled, the control section causes the display to simultaneously display, in a split manner, the second setting screen and the first setting screen on the display section when the first operation is received while the second setting screen is being displayed on the display section. According to this configuration, any sections not covered by one of the first setting screen and the second setting screen can be compensated by the other, and the first setting screen and the second setting screen can be visually checked at the same time. Therefore, the usability of the user is improved.

(4) The electronic device according to any one of the (1) to (3) may further include a setting section that is referred to by the control section 50 that received the first operation and that enables one of a full screen display and a split screen display, wherein in a case where the full screen display is enabled, the control section switches from the second setting screen to the first setting screen when the first operation is received while the second setting screen is displayed on the display section. According to this configuration, any sections not covered by one of the first setting screen and the second setting screen can be compensated by the other, and the first setting screen and the second setting screen can be visually checked at the same time. Therefore, the usability of the user is improved.

(5) The electronic device according to any one of (1) to (4) may be such that the first operation is an operation of selecting a help button in the second setting screen as the selected section and when the second setting screen is displayed, the control section, upon receiving selection of the help button, causes the display to simultaneously display, in a split manner, the second setting screen and a help screen on the display section as the first setting screen associated with the help button. According to this configuration, even if the second setting screen does not include the second display data for the help screen, the help screen can be supplemented with the help screen using the first display data stored in the storage section on the electronic device side, and thus the usability for the user is improved.

(6) The electronic device according to any one of (1) to (5) may be such that when the control section performs split display on the display section, the control section is configured to allocate a display region for the help screen that is larger than a display region for the second setting screen. According to this configuration, the help screen is displayed in a large size, and thus the user can more easily check the content.

(7) The electronic device according to any one of (1) to (6) may be such that the control section is configured to, when a scroll operation on the second setting screen is received, scroll the second setting screen but not scroll the first setting screen. According to this configuration, the second setting screen can be operated while checking the first setting screen (for example, the help screen), and thus the usability for the user is good. If the first setting screen is scrolled together with the second setting screen, it is difficult to check the information on the first setting screen.

(8) The electronic device according to any one of (1) to (6) may be such that the control section is configured to, when a scroll operation on the first setting screen is received, scroll the first setting screen but not scroll the second setting screen.

According to this configuration, the user can scroll the first setting screen (for example, the help screen) and check other information (for example, help information) while keeping the display of the second setting screen, and thus the usability is good.

(9) The electronic device according to any one of (1) to (6) may be such that the control section scrolls both the first setting screen and the second setting screen when a scroll operation on one of the first setting screen and the second setting screen is received. According to this configuration, since the first setting screen (for example, the help screen) is scrolled together, it is possible to save the time and effort to search for the information (for example, the help information) of the first setting screen, and the usability for the user is good.

(10) The electronic device according to any one of (1) to (9) may be such that the help screen includes a setting operation section that enables a change of setting content related to a setting change option corresponding to the selected section selected by the first operation and when the control section receives a change of the setting content based on an operation of the setting operation section on the help screen, the control section reflects the change of the setting content in the setting change option on the second setting screen. According to this configuration, since the setting operation for changing the setting content can be performed on the help setting screen, the usability for the user is improved.

(11) An electronic device includes an action section that performs an action to generate the image using a medium,

the electronic device including a display section configured to display a setting screen that is to be visually checked by a user after setting an image generation condition, which is a condition for generating the image; an operation section configured to enable an operation on the setting screen; a storage section configured to store one or more pieces of first display data to display a first setting screen, which is one display mode of the setting screen; a communication section connectable via a network to a server storing one or more pieces of second display data that enables display of a second setting screen, which is another display mode of the setting screen; and a control section that controls the display section, wherein the control section when a second operation of selecting a selected section in the first setting screen is received by the operation section while the first setting screen based on the first display data is being displayed on the display section, sends second operation position information that indicates an operation position of the second operation to the server and causes the first setting screen and the second setting screen, which is based on the second display data received from the server as a response to the second operation position information, to be simultaneously displayed, in a split manner, on the display section.

According to this configuration, the display content that cannot be displayed on the first setting screen can be supplemented by the second setting screen, and the usability of the user is improved. For example, the display content of each user that cannot be prepared as the first setting screen can be split and simultaneously displayed on the display section as the second setting screen. Therefore, any portions not supported by one of the first setting screen and the second setting screen can be compensated by the other, and the first and the second setting screens can be visually checked at the same time, so that the usability of the user is improved.

(12) The electronic device according to (11) may such that the electronic device is communicably connected to a terminal device connected to the server via the network, the first setting screen is a storage destination designation screen including, as the selected section, a storage destination designation portion enabling designation of a storage destination of data related to an image generated by the electronic device, and when the control section receives the second operation in which the storage destination designation portion in the storage destination designation screen is selected, the control section simultaneously displays, in a split manner, the storage destination designation screen and a folder list screen received from the terminal device via the server on the display section.

According to this configuration, even if the display content of the storage destination designation screen as the first setting screen is insufficient for the display content that can be displayed as the second setting screen, the storage destination designation screen and the folder list screen received from the terminal device via the server can be displayed simultaneously by splitting the display section. By this, the storage destination designation screen and the folder list screen of the terminal device are displayed simultaneously, so that the usability of the user is improved.

(13) The electronic device according to any one of (1) to (12) may such that the electronic device is an image reading device including, as the action section, a reading section that reads a document sheet as the medium. According to this configuration, when the image generation conditions (image reading conditions) are set, any portion not supported by one of the first setting screen and the second setting screen are able to be compensated by the other, and the first setting screen and the second setting screen can be visually checked at the same time. Therefore, the usability of the user is improved.

(14) The electronic device according to any one of (1) to (12) may such that the electronic device is an image forming device including, as the action section, an image forming section that forms an image on the medium. According to this configuration, when the image generation conditions (for example, the image generation conditions) are set, any portions not covered by one of the first setting screen and the second setting screen are able to be compensated by the other, and the first setting screen and the second setting screen can be visually checked at the same time. Therefore, the usability of the user is improved.

(15) A server is connected to the electronic device according to any one of (1) to (10) via a network and the server includes a second storage section configured to store one or more pieces of second display data that enables displaying a second setting screen that is another display mode of the setting screen; a server-side display control section that sends, to the electronic device, together with the second display data, an instruction to display the second setting screen based on the second display data on the display section; and a second split display control section configured to, when the control section of the electronic device receives a first operation to select a selected section in the second setting screen by the operation section while the second setting screen based on the second display data is being displayed on the display section, receive, from the electronic device via the network, first operation position information based on the first operation, wherein the second split display control section sends, to the electronic device, a display instruction to cause display, on the display section, of the first setting screen based on the first display data associated with the first operation position information, to cause the control section to simultaneously display, in a split manner, on the display section, the second setting screen and the first setting screen, which is based on the first display data that was read from the storage section in accordance with the display instruction. According to this configuration, by the server, any portions not covered by one of the first setting screen and the second setting screen(for example, the second setting screen) can be compensated by the other (for example, the first setting screen) in the electronic device, and the first setting screen and the second setting screen can be visually checked at the same time. Therefore, the usability of the user is improved.

(16) A server is connected to the electronic device according to (11) or (12) via a network and the server includes a second storage section configured to store one or more pieces of second display data that enables displaying a second setting screen that is another display mode of the setting screen; a server-side display control section that sends, to the electronic device, together with the second display data, an instruction to display the second setting screen based on the second display data on the display section; and a second split display control section that receives second operation position information from the electronic device via the network, wherein the second split display control section performs an image acquisition process associated with the second operation position information to acquire new second display data different from the second display data that was stored in the second storage section before the image acquisition process, and sends, to the electronic device together with the new second display data, a display instruction to cause the display section to display the second setting screen based on the new second display data, thereby causing the control section to simultaneously display, in a split manner, the first setting screen and the second setting screen based on the new second display data on the display section. According to this configuration, by the server, any portions not covered in one of the first setting screen and the second setting screen(for example, the first setting screen) can be compensated for by the other (for example, the second setting screen) in the electronic device, and the first setting screen and the second setting screen can be visually checked at the same time. Therefore, the usability of the user is improved.

(17) A display system includes the electronic device according to any one of (1) to (10) and the server according to any one of (1) to (10) and (15).

According to this configuration, by the server, any portions not covered by one of the first setting screen and the second setting screen can be compensated by the other in the electronic device, and the first setting screen and the second setting screen can be visually checked at the same time. Therefore, the usability of the user is improved. (18) A display system includes the electronic device according to (11) or (12), and the server according to any one of (11), (12), and (16).

According to this configuration, by the server, any portions not covered by one of the first setting screen and the second setting screen can be compensated by the other in the electronic device, and the first setting screen and the second setting screen can be visually checked at the same time. Therefore, the usability of the user is improved.

(19) An electronic device display control method controls a display section provided in an electronic device, the electronic device including an action section that performs an action to generate an image using a medium, a display section configured to display a setting screen that is to be visually checked by a user after setting an image generation condition, which is a condition for generating the image, the operation section configured to perform the operation on the setting screen, the storage section configured to store one or more pieces of first display data to display the first setting screen that is one display mode of the setting screen, and a communication section connectable via a network to a server storing one or more pieces of second display data that enables display of a second setting screen, which is another display mode of the setting screen, the display control method including

(A1) when the second setting screen based on the second display data is being displayed on the display section, receiving a first operation in which a selected section in the second setting screen is selected by the operation section and

(A2) when the first operation is received, the second setting screen and a first setting screen based on one piece of the first display data associated with the first operation are displayed on the display section simultaneously in a split manner.

According to this method, any portions not covered by one of the first setting screens and the second setting screen can be compensated by the other, and the first setting screen and the second setting screen can be visually checked at the same time. Therefore, the usability of the user is improved.

(20) An electronic device display control method controls a display section provided in the electronic device, the electronic device including an action section that performs an action to generate an image using a medium, a display section configured to display a setting screen that is to be visually checked by a user after setting an image generation condition, which is a condition for generating the image, the operation section configured to perform the operation on the setting screen, the storage section configured to store one or more pieces of first display data to display the first setting screen that is one display mode of the setting screen, and a communication section connectable via a network to a server storing one or more pieces of second display data that enables display of a second setting screen, which is another display mode of the setting screen, the display control method including

(B1) when the first setting screen based on the first display data is displayed on the display section, upon receiving a second operation in which a selected section in the first setting screen is selected by the operation section, sending second operation position information indicating an operation position of the second operation to the server and

(B2) displaying, on the display section simultaneously in a split manner, the first setting screen and the second setting screen, which is based on the second display data received from the server as a response to the second operation position information.

According to this method, any portions not covered by one of the first setting screens and the second setting screen can be compensated by the other, and the first setting screen and the second setting screen can be visually checked at the same time. Therefore, the usability of the user is improved.

What is claimed is:

1. An electronic device including an action section that performs an action to generate an image using a medium, the electronic device comprising:
a display section configured to display a setting screen that is to be visually checked by a user after setting an image generation condition, which is a condition for generating the image;
an operation section configured to enable an operation on the setting screen;
a storage section configured to store one or more pieces of first display data to display a first setting screen, which is one display mode of the setting screen;
a communication section connectable via a network to a server storing one or more pieces of second display data that enables display of a second setting screen, which is another display mode of the setting screen; and
a control section configured to, when a first operation of selecting a selected section in the second setting screen is received by the operation section while the second setting screen based on the second display data is being displayed on the display section, cause the display section to simultaneously display, in a split manner, the second setting screen and the first setting screen, which is based on one piece of first display data associated with the first operation.

2. The electronic device according to claim 1, wherein
the control section is configured to, when the first operation is received while the second setting screen is being displayed on the display section, switch from the second setting screen to the first setting screen, which is based on the one piece of the first display data associated with the first operation.

3. The electronic device according to claim 1, further comprising:
a setting section that is referred to by the control section that received the first operation and that sets one of a full screen display and a split screen display to be enabled, wherein
in a case where the split screen display is enabled, the control section causes the display to simultaneously display, in a split manner, the second setting screen and the first setting screen on the display section when the first operation is received while the second setting screen is being displayed on the display section.

4. The electronic device according to claim 1, further comprising:
a setting section that is referred to by the control section that received the first operation and that sets one of a full screen display and a split screen display to be enabled, wherein
in a case where the full screen display is enabled, the control section switches from the second setting screen to the first setting screen when the first operation is received while the second setting screen is displayed on the display section.

5. The electronic device according to claim 1, wherein
the first operation is an operation of selecting a help button in the second setting screen as the selected section and
when the second setting screen is displayed, the control section, upon receiving selection of the help button, causes the display to simultaneously display, in a split manner, the second setting screen and a help screen on the display section as the first setting screen associated with the help button.

6. The electronic device according to claim 5, wherein
when the control section performs split display on the display section, the control section is configured to allocate a display region for the help screen that is larger than a display region for the second setting screen.

7. The electronic device according to claim 1, wherein
the control section is configured to, when a scroll operation on the second setting screen is received, scroll the second setting screen but not scroll the first setting screen.

8. The electronic device according to claim 1, wherein
the control section is configured to, when a scroll operation on the first setting screen is received, scroll the first setting screen but not scroll the second setting screen.

9. The electronic device according to claim 1, wherein
the control section scrolls both the first setting screen and the second setting screen when a scroll operation on one of the first setting screen and the second setting screen is received.

10. The electronic device according to claim 5, wherein
the help screen includes a setting operation section that enables a change of setting content related to a setting change option corresponding to the selected section selected by the first operation and
when the control section receives a change of the setting content based on an operation of the setting operation section on the help screen, the control section reflects the change of the setting content in the setting change option on the second setting screen.

11. An electronic device including an action section that performs an action to generate an image using a medium, the electronic device comprising:
a display section configured to display a setting screen that is to be visually checked by a user after setting an image generation condition, which is a condition for generating the image;
an operation section configured to enable an operation on the setting screen;
a storage section configured to store one or more pieces of first display data to display a first setting screen, which is one display mode of the setting screen;
a communication section connectable via a network to a server storing one or more pieces of second display data that enables display of a second setting screen, which is another display mode of the setting screen; and
a control section that controls the display section, wherein
the control section
when a second operation of selecting a selected section in the first setting screen is received by the operation section while the first setting screen based on the first display data is being displayed on the display section, sends second operation position information that indicates an operation position of the second operation to the server and
causes the first setting screen and the second setting screen, which is based on the second display data received from the server as a response to the second operation position information, to be simultaneously displayed, in a split manner, on the display section.

12. The electronic device according to claim 11, wherein
the electronic device is communicably connected to a terminal device connected to the server via the network,
the first setting screen is a storage destination designation screen including, as the selected section, a storage destination designation portion enabling designation of a storage destination of data related to an image generated by the electronic device, and
when the control section receives the second operation in which the storage destination designation portion in the storage destination designation screen is selected, the control section simultaneously displays, in a split manner, the storage destination designation screen and a folder list screen received from the terminal device via the server on the display section.

13. The electronic device according to claim 1, wherein
the electronic device is an image reading device including, as the action section, a reading section that reads a document sheet as the medium.

14. The electronic device according to claim 1, wherein
the electronic device is an image forming device including, as the action section, an image forming section that forms an image on the medium.

15. A server connected to the electronic device according to claim 1 via a network, the server comprising:
a second storage section configured to store one or more pieces of second display data that enables displaying a second setting screen that is another display mode of the setting screen;
a server-side display control section that sends, to the electronic device, together with the second display data, an instruction to display the second setting screen based on the second display data on the display section; and
a second split display control section configured to, when the control section of the electronic device receives a first operation to select a selected section in the second setting screen by the operation section while the second setting screen based on the second display data is being displayed on the display section, receive, from the electronic device via the network, first operation position information based on the first operation, wherein
the second split display control section sends, to the electronic device, a display instruction to cause display, on the display section, of the first setting screen based on the first display data associated with the first operation position information, to cause the control section to simultaneously display, in a split manner, on the display section, the second setting screen and the first setting screen, which is based on the first display data that was read from the storage section in accordance with the display instruction.

16. A server connected to the electronic device according to claim 11 via a network, the server comprising:
a second storage section configured to store one or more pieces of second display data that enables displaying a second setting screen that is another display mode of the setting screen;
a server-side display control section that sends, to the electronic device, together with the second display data, an instruction to display the second setting screen based on the second display data on the display section; and
a second split display control section that receives second operation position information from the electronic device via the network, wherein
the second split display control section performs an image acquisition process associated with the second operation position information to acquire new second display data different from the second display data that was stored in the second storage section before the image acquisition process, and sends, to the electronic device together with the new second display data, a display instruction to cause the display section to display the second setting screen based on the new second display data, thereby causing the control section to simultaneously display, in a split manner, the first setting screen and the second setting screen based on the new second display data on the display section.

17. A display system comprising:
the electronic device according to claim 1 and the server according to claim 1.the electronic device according to claim 1 and the server according to claim 1.

18. The display system comprising:
the electronic device according to claim 11, and the server according to claim 11.the electronic device according to claim 11, and the server according to claim 11.

19. A display control method for controlling a display section included in an electronic device,
the electronic device including
an action section that performs an action to generate an image using a medium;
a display section configured to display a setting screen that is to be visually checked by a user after setting an image generation condition, which is a condition for generating the image;
an operation section configured to enable an operation on the setting screen;
a storage section configured to store one or more pieces of first display data to display a first setting screen, which is one display mode of the setting screen; and
a communication section connectable via a network to a server storing one or more pieces of second display data that enables display of a second setting screen, which is another display mode of the setting screen,
the display control method comprising:
(A1) when the second setting screen based on the second display data is being displayed on the display section, receiving a first operation in which a selected section in the second setting screen is selected by the operation section and
(A2) when the first operation is received, displaying, on the display section simultaneously in a split manner, the second setting screen and a first setting screen based on the first display data associated with the first operation.

20. A display control method for controlling the display section included in an electronic device,
the electronic device including
an action section that performs an action to generate an image using a medium,
a display section configured to display a setting screen that is to be visually checked by a user after setting an image generation condition, which is a condition for generating the image,
the operation section configured to perform the operation on the setting screen,
the storage section configured to store one or more pieces of first display data to display the first setting screen that is one display mode of the setting screen, and
a communication section connectable via a network to a server storing one or more pieces of second display data that enables display of a second setting screen, which is another display mode of the setting screen,
the display control method comprising:
(B1) when the first setting screen based on the first display data is displayed on the display section, upon receiving a second operation in which a selected section in the first setting screen is selected by the operation section, sending second operation position information indicating an operation position of the second operation to the server and
(B2) displaying, on the display section simultaneously in a split manner, the first setting screen and the second setting screen, which is based on the second display data received from the server as a response to the second operation position information.
